(19) United States
(12) Patent Application Publication
(10) Pub. No.: US 2023/0244226 A1
(43) Pub. Date: Aug. 3, 2023

(54) METHODS AND APPARATUS FOR PROVIDING TELEOPERATIONS SUPPORT

(71) Applicant: Nuro, Inc., Mountain View, CA (US)

(72) Inventors: Emily Anna Weslosky, Mountain View, CA (US); Mark Rodrigo, Ventura, CA (US); Benjamin Caleb Carroll, San Francisco, CA (US); Yichao (Roger) Shen, Mountain View, CA (US); Eric Yuhao Yi, Foster City, CA (US); Nicholas Tang Moy, San Francisco, CA (US); William Paul Maddern, Sunnyvale, CA (US); Minlin Zhang, Mountain View, CA (US)

(73) Assignee: Nuro, Inc., Mountain View, CA (US)

(21) Appl. No.: 18/150,508

(22) Filed: Jan. 5, 2023

Related U.S. Application Data
(60) Provisional application No. 63/306,331, filed on Feb. 3, 2022.
(60) Provisional application No. 63/347,888, filed on Jun. 1, 2022.

(51) Int. Cl. G05D 1/00; B60W 60/00

(52) U.S. Cl. CPC G05D 1/0027; B60W 60/0015; B60W 2556/45

(57) ABSTRACT

According to one aspect, a method includes obtaining, at a monitoring arrangement, a first supervisory request from a first vehicle, the first supervisory request arranged to indicate that the first vehicle has identified a first potential issue. The method also includes processing, at the monitoring arrangement, the first supervisory request, wherein processing the first supervisory request includes determining whether the first potential issue is to be mitigated. When it is determined that the first potential issue is to be mitigated, information is provided from the monitoring arrangement to a control arrangement, and the control arrangement takes control of the first vehicle based on the information.

### PRIORITY CLAIM

This patent application claims the benefit of priority under 35 U.S.C. § 119 to U.S. Provisional Patent Application No. 63/306,331, filed Feb. 3, 2022, and entitled “Methods and Apparatus for Providing Teleoperations Support,” and U.S. Provisional Patent Application No. 63/347,888, filed Jun. 1, 2022, and entitled “Methods and Apparatus for Providing Supervisory Teleoperations Support,” which are each incorporated herein by reference in its entirety.

### TECHNICAL FIELD

The disclosure relates to providing systems for use with autonomous vehicles. More particularly, the disclosure relates to systems which provide teleoperations monitoring and operational support for autonomous vehicles.

### BACKGROUND

Fleets of autonomous or semi-autonomous vehicles often utilize remote operators, e.g., operators of teleoperations systems or operator of remote controls. An operator of a teleoperations system must generally keep an eye on a display screen which depicts the environment around the vehicle that the operator is monitoring, and be ready to take control if needed, as for example when the vehicle may not operate safely in autonomous mode. When the operator takes control of the vehicle, the operator uses the teleoperations system to remotely operate the vehicle. In some situations, an operator of a teleoperations system may determine when to take control of a vehicle that is operating autonomously. In other situations, a vehicle that is operating autonomously may effectively request that an operator of a teleoperations system take control of the vehicle.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of a teleoperations monitoring and operations platform which includes a teleoperations queue within which a teleoperations monitor arrangement monitors a fleet of vehicles in accordance with an embodiment.

FIG. 5 is a diagrammatic representation of a teleoperations monitoring and operations platform which does not include a teleoperations queue within which a teleoperations monitor arrangement monitors a fleet of vehicles in accordance with an embodiment.

FIG. 6 is a diagrammatic representation of a teleoperations operations platform which includes a teleoperations queue which may be utilized by a fleet of vehicles in accordance with an embodiment.

FIG. 7 is a diagrammatic representation of a teleoperations monitoring and operations platform which includes a teleoperations queue within which a vehicle of a fleet of vehicles may request teleoperations monitoring in accordance with an embodiment.

FIG. 8A is a diagrammatic representation of a teleoperations monitoring and operations platform which includes a teleoperations queue within which a teleoperations monitor arrangement monitors at least a part of fleet of vehicles and a self-monitoring vehicle identifies a need for monitoring in accordance with an embodiment.

FIG. 8B is a diagrammatic representation of a teleoperations monitoring and operations platform, e.g., platform 850 of FIG. 8A which includes a teleoperations queue within which a teleoperations monitor arrangement monitors at least a part of fleet of vehicles and the teleoperations monitor arrangement identifies a need for monitoring in accordance with an embodiment.

FIG. 9A is a diagrammatic representation of a teleoperations monitoring and operations platform which does not include a teleoperations queue within which a teleoperations monitor arrangement monitors at least a part of fleet of vehicles and a self-monitoring vehicle identifies a need for monitoring in accordance with an embodiment.

FIG. 9B is a diagrammatic representation of a teleoperations monitoring and operations platform, e.g., platform 950 of FIG. A, which does not include a teleoperations queue within which a teleoperations monitor arrangement monitors at least a part of fleet of vehicles and the teleoperations monitor arrangement identifies a need for monitoring in accordance with an embodiment.

FIG. 10 is a diagrammatic representation of a teleoperations monitoring and operations platform which shows communications between vehicles and an overall teleoperations arrangement in accordance with an embodiment.

FIG. 11 is a block diagram representation of a teleoperations operator arrangement, e.g., teleoperations operator arrangement 1054a of FIG. 10, in accordance with an embodiment.

FIG. 12 is a block diagram representation of a teleoperations monitor arrangement, e.g., teleoperations monitor arrangement 1052 of FIG. 10, in accordance with an embodiment.

FIG. 13 is a block diagram representation of a teleoperations queue arrangement, e.g., teleoperations queue arrangement 1056 of FIG. 10, in accordance with an embodiment.

FIG. 14 is a process flow diagram which illustrates a method of enabling a teleoperations operator to assume responsibility for operating a vehicle when a platform supports monitoring and queues in accordance with an embodiment.

FIG. 15 is a process flow diagram which illustrates a method of enabling a teleoperations operator to assume responsibility for operating a vehicle when a platform supports monitoring in accordance with an embodiment.

FIG. 16 is a process flow diagram which illustrates a method of enabling a teleoperations operator to assume responsibility for operating a vehicle when a platform supports queues in accordance with an embodiment.

FIG. 17 is a block diagram representation of an autonomous vehicle that includes a self-monitoring arrangement in accordance with an embodiment.

FIG. 18A is a diagrammatic representation of a teleoperations monitoring and operations platform which includes a self-monitoring vehicle configured to request monitoring when such a request results in a teleoperations operator arrangement remotely controlling the self-monitoring vehicle in accordance with an embodiment.

FIG. 18B is a diagrammatic representation of a teleoperations monitoring and operations platform which includes a self-monitoring vehicle, e.g., teleoperations monitoring and operations platform 450 and self-monitoring vehicle “A” 1801a of FIG. 18A, that continues to operate autonomously after a monitoring process in accordance with an embodiment.

FIG. 19 is a process flow diagram which illustrates a method of operating a teleoperations monitoring and operations platform in accordance with an embodiment.

FIG. 20 is a block diagram representation of a teleoperations monitor arrangement in accordance with an embodiment.

FIG. 21 is a process flow diagram which illustrates a method of operating a vehicle when the vehicle identifies a potential issue that may be mitigated by engaging a teleoperations monitor arrangement in accordance with an embodiment.

FIG. 22 is a process flow diagram which illustrates a method of operation of a teleoperations monitor arrangement in accordance with an embodiment.

FIG. 23 is a process flow diagram which illustrates a method of using a teleoperations monitor arrangement in an overall system in which supervisory requests are associated with critical levels in accordance with an embodiment.

FIG. 24 is a diagrammatic representation of communications within a teleoperations monitoring and operations platform which includes a self-monitoring vehicle in accordance with an embodiment.

FIG. 25 is a block diagram representation of an assisted auto arrangement, e.g., assisted auto arrangement 2080 of FIG. 20, in accordance with an embodiment.

FIG. 26 is a process flow diagram which illustrates a method of determining whether monitoring of an autonomous vehicle is to be requested, e.g., step 2113 of FIG. 21, in accordance with an embodiment.

FIG. 27 is a process flow diagram which illustrates a method of determining a category for a supervisory request obtained from an autonomous vehicle whether a teleoperations monitor is to be requested, e.g., step 2213 of FIG. 23, in accordance with an embodiment.

FIG. 28 is a process flow diagram which illustrates a method of processing supervisory requests and substantially automatic monitoring requests relating to an autonomous vehicle in accordance with an embodiment.

FIG. 29 is a diagrammatic representation of a teleoperations monitoring and operations platform which includes teleoperations monitor administrator configured to select a particular self-monitoring vehicle to be expedited for control by a teleoperations operator arrangement in accordance with an embodiment.

### DESCRIPTION OF EXAMPLE EMBODIMENTS

### General Overview

In one embodiment, a method includes obtaining, at a monitoring arrangement, a first supervisory request from a first vehicle, the first supervisory request arranged to indicate that the first vehicle has identified a first potential issue. The method also includes processing, at the monitoring arrangement, the first supervisory request, wherein processing the first supervisory request includes determining whether the first potential issue is to be mitigated. When it is determined that the first potential issue is to be mitigated, information is provided from the monitoring arrangement to a control arrangement, and the control arrangement takes control of the first vehicle based on the information.

In another embodiment, logic is encoded in one or more tangible non-transitory, computer-readable media for execution. When executed, the logic is operable to obtain a first supervisory request from a first vehicle, the first supervisory request arranged to indicate that the first vehicle has identified a first potential issue. The logic is also operable to process the first supervisory request, wherein the logic operable to process the first supervisory request includes logic operable to determine whether the first potential issue is to be mitigated, and to provide information to a control arrangement when it is determined that the first potential issue is to be mitigated, wherein the control arrangement takes control of the first vehicle based on the information, the control arrangement being separate from the first vehicle.

According to still another embodiment, a system or a platform includes a plurality of vehicles, a monitoring arrangement, and a control arrangement. Each vehicle of the plurality of vehicles is configured to operate autonomously, and the plurality of vehicles includes a first vehicle. The monitoring arrangement is configured to monitor the plurality of vehicles, and includes at least one display screen arranged to display information provided by the plurality of vehicles. The monitoring arrangement obtains a first supervisory request from the first vehicle, and is further being arranged to service the first supervisory request to determine whether the first vehicle is to be controlled remotely. The control arrangement is configured to control the plurality of vehicles remotely, and takes control of the first vehicle when the monitoring arrangement determines that the first vehicle is to be controlled remotely.

A platform may include one or more teleoperations monitoring arrangements which may each be used to monitor multiple autonomous vehicles. The platform also includes one or more teleoperations operating arrangements which each enable a vehicle to be remotely controlled. When a teleoperations monitor using a teleoperations monitoring arrangement identifies a vehicle that would benefit from being remotely operated, the teleoperations monitor may effectively assign control of the vehicle to a teleoperations operator who may use a teleoperations operator arrangement to take over control of the vehicle. The platform may further include a teleoperations queue that may effectively queue vehicles awaiting control by a teleoperations operator. The teleoperations queue may be prioritized to provide teleoperations to vehicles based on the types of situations the vehicles are in, and/or the queue may be used to assign suitable teleoperations operators to vehicles based on the expertise of each teleoperations operator.

A platform may include one or more teleoperations monitor arrangements which may each be used to monitor multiple autonomous vehicles. The platform also includes one or more teleoperations operating arrangements which each enable a vehicle to be remotely controlled. Autonomous vehicles which may be monitored by a teleoperations monitor arrangement and remotely controlled by a teleoperations operating arrangement may be self-monitoring such that when an autonomous vehicle determines that monitoring using a teleoperations monitor arrangement may be beneficial, the autonomous vehicle may request monitoring. Upon obtaining or otherwise receiving a request for monitoring from the autonomous vehicle, the teleoperations monitor arrangement may monitor the autonomous vehicle and assign a teleoperations operating arrangement to remotely control the autonomous vehicle as appropriate.

### DESCRIPTION

Teleoperations systems are often used to support the operation of autonomous and semi-autonomous vehicles. For example, an autonomous vehicle may be monitored using a teleoperations system such that if the vehicle encounters an issue while operating autonomously, the teleoperations system may be used by a remote operator to control the vehicle. Typically, a single teleoperations system may be used to monitor and to take control of a single vehicle at any given time.

While having a dedicated teleoperations system that enables an operator to drive a remote vehicle for each vehicle of a fleet of autonomous vehicles allows each vehicle to operate safely in the event that autonomous mode is not possible, the use of dedicated teleoperations systems may be an inefficient use of resources. When a vehicle is capable of operating in an autonomous mode for a majority of the time that the vehicle is in use, the allocation of a dedicated teleoperations system and a dedicated teleoperator may be inefficient. In addition, for relatively large fleets of autonomous vehicles, obtaining and maintaining the number of dedicated teleoperations systems needed to facilitate the same deployment of the autonomous vehicles may be impractical.

By enabling multiple vehicles which are operating in an autonomous mode to be monitored using a single teleoperations monitoring station and, when remote operation of one of the vehicles is desired, assigning control to a teleoperations operating station, vehicles may be monitored while enabling resources to be allocated efficiently. A single teleoperations monitoring station or arrangement may include one or more display screens which enable multiple vehicles to be monitored. When a teleoperations monitor, e.g., a person responsible for using a teleoperations monitoring arrangement to monitor or otherwise keep watch on multiple vehicles, determines that a vehicle would benefit from being remotely operated, the teleoperations monitor may effectively assign control of the vehicle to a teleoperations operator, e.g., a person responsible for using a teleoperations operator arrangement to remotely control the vehicle. As such, multiple vehicles may be monitored by one teleoperations monitor and, when one of the multiple vehicles may need to be remotely operated, the teleoperations operator may cause a teleoperations operator to effectively take control of the vehicle.

In one embodiment, when a teleoperations monitoring station is effectively contacted by a vehicle when the vehicle anticipates a situation in which remote operation of the vehicle by a teleoperator may be desired, the efficient allocation of resources may be further improved. A single teleoperations monitoring station or arrangement may include a display screen which may be used to monitor a vehicle when a vehicle requests monitoring, e.g., issues a supervisory request. When a teleoperations monitor, e.g., a person responsible for using a teleoperations monitor arrangement to monitor a vehicle in response to a supervisory request, determines that a vehicle would benefit from being remotely operated, the teleoperations monitor may effectively assign control of the vehicle to an available teleoperations operator, e.g., a person responsible for using a teleoperations operator arrangement to remotely control the vehicle.

A teleoperations queue may be used to essentially queue vehicles which are awaiting assignment of teleoperations operators to remotely control the vehicles. Self-monitoring vehicles may place themselves into the teleoperations queue when they identify issues, and/or a teleoperations monitor may place a vehicle into the teleoperations queue when the teleoperations monitor identifies an issue with the vehicle.

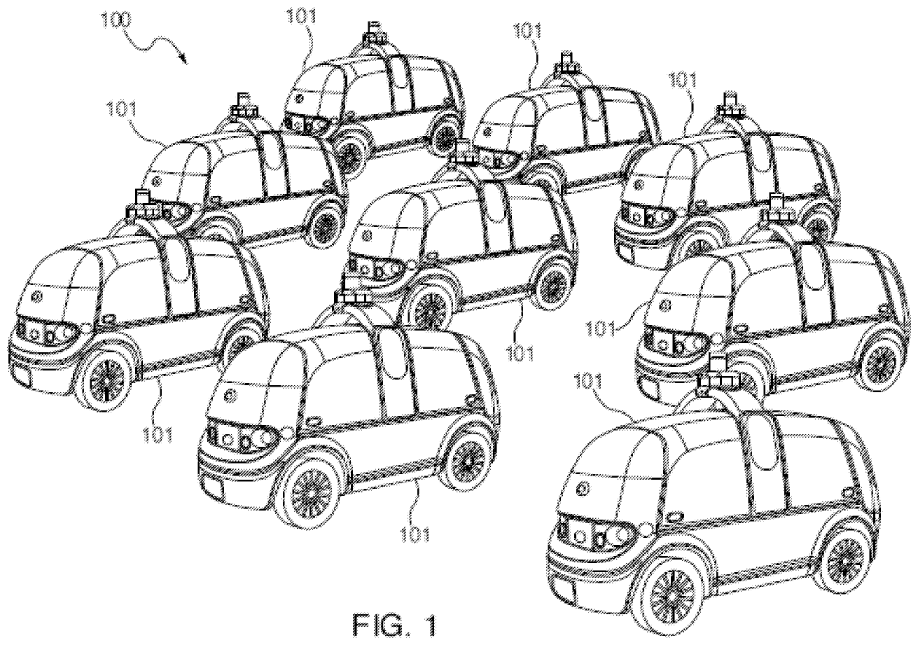

A platform which includes at least one teleoperations monitoring arrangement and one or more teleoperations operator arrangements may include a fleet of vehicles capable of operating in fully autonomous and/or semi-autonomous modes. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

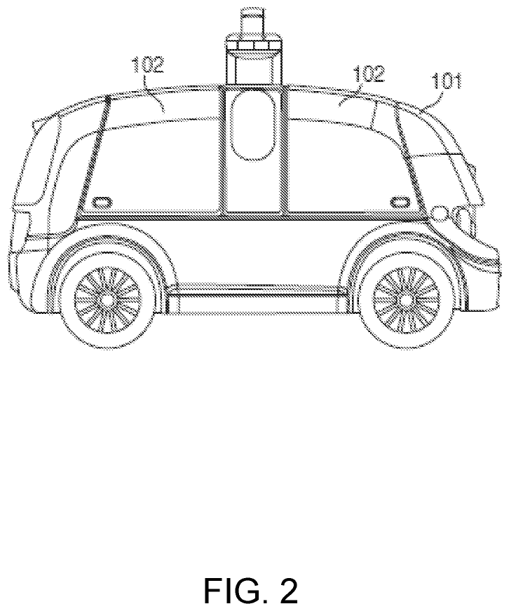

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

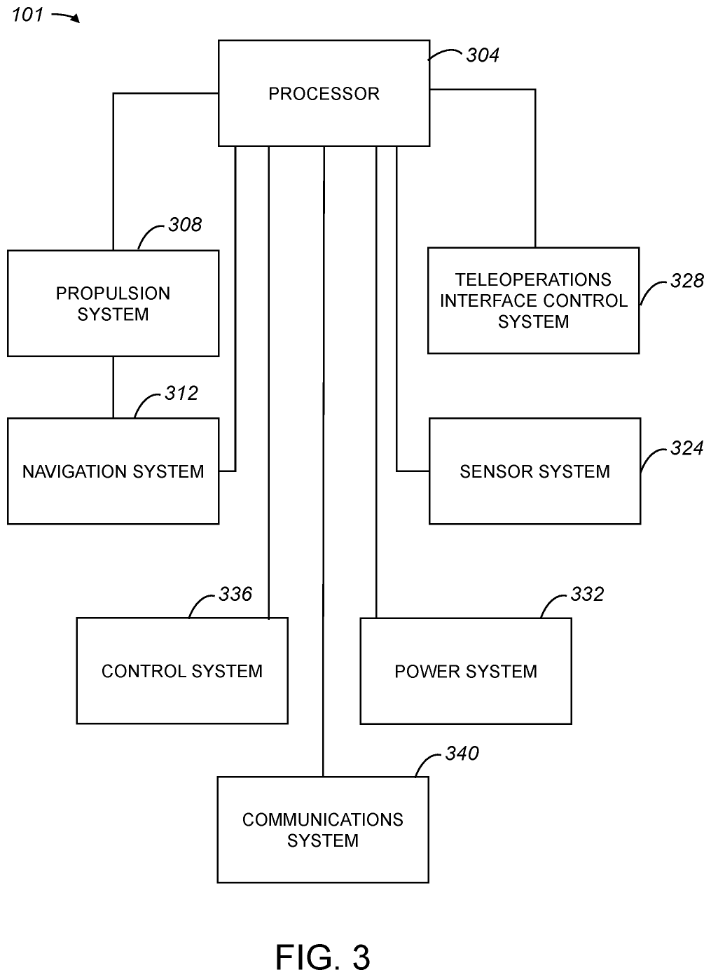

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a teleoperations interface control system 328, a power system 332, a control system 336, and a communications system 340. It should be appreciated that processor 304, propulsion system 308, navigation system 312, sensor system 324, teleoperations interface control system 328, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Teleoperations interface control system 328 generally enables vehicle 101 to be controlled remotely, as for example by a teleoperations operator arrangement. That is, teleoperations interface control system 328 enables vehicle 101 to operate by obtaining and processing instructions provided by a teleoperations operator arrangement. Additionally, teleoperations interface control system 328 may enable vehicle 101 to determine when vehicle 101, while operating autonomously, may benefit from being controlled via teleoperations and to request remote monitoring and/or control by a teleoperator. In one embodiment, teleoperations interface control system 328 enables vehicle 101 to communicate with a teleoperations monitor arrangement, a teleoperations operator arrangement, and/or a teleoperations queue. A teleoperations monitor arrangement, a teleoperations operator arrangement, and a teleoperations queue will be discussed below.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate fully autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

A teleoperations monitoring and operations platform may generally include a fleet of vehicles which are capable of operating autonomously and remotely, e.g., through teleoperations, at least one monitoring system which enables multiple vehicles to be monitored substantially simultaneously, and one or more teleoperations systems which enable vehicles to be teleoperated. In one embodiment, a platform may include a teleoperations queue that may be used to substantially prioritize or to otherwise manage the assignment of teleoperations operators to take control of vehicles.

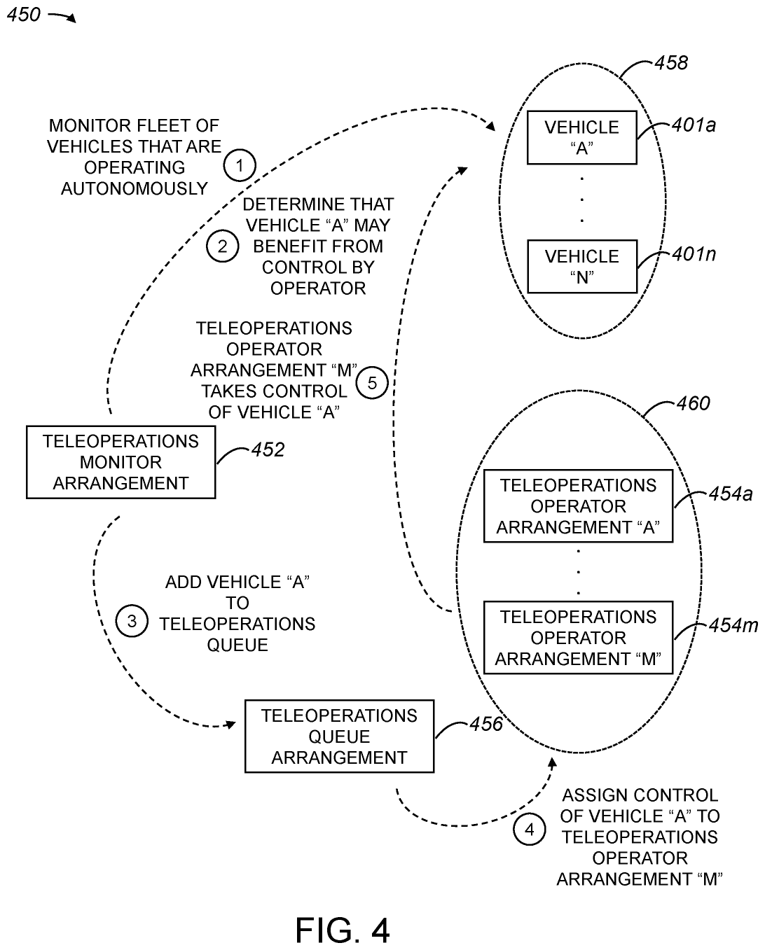

FIG. 4 is a diagrammatic representation of a teleoperations monitoring and operations platform which includes a teleoperations queue within which a teleoperations monitor arrangement monitors a fleet of vehicles in accordance with an embodiment. A teleoperations monitoring and operations platform 450 includes a fleet 458 of vehicles 401a-n which are capable of operating autonomously, e.g., fully autonomously and/or semi-autonomously. Vehicles 401a-n may each generally include the components and functionality described above with respect to vehicle 101 of FIGS. 2 and 3. The number of vehicles 401a-n included in fleet 458 may vary widely. Platform 450 also includes at least one teleoperations monitor arrangement 452 configured to monitor fleet 458, a group 460 of teleoperations operator arrangements 454a-m, and a teleoperations queue arrangement 456. The number of teleoperations operator arrangements 454a-m included in group 460 may generally vary widely. In general, the number of vehicles 401a-n may be substantially equal to or exceed the number of teleoperations operator arrangements 454a-m. It should be appreciated, however, that the number of vehicles 401a-n is not limited to being substantially equal to or greater than the number of teleoperations operator arrangements 454a-m.

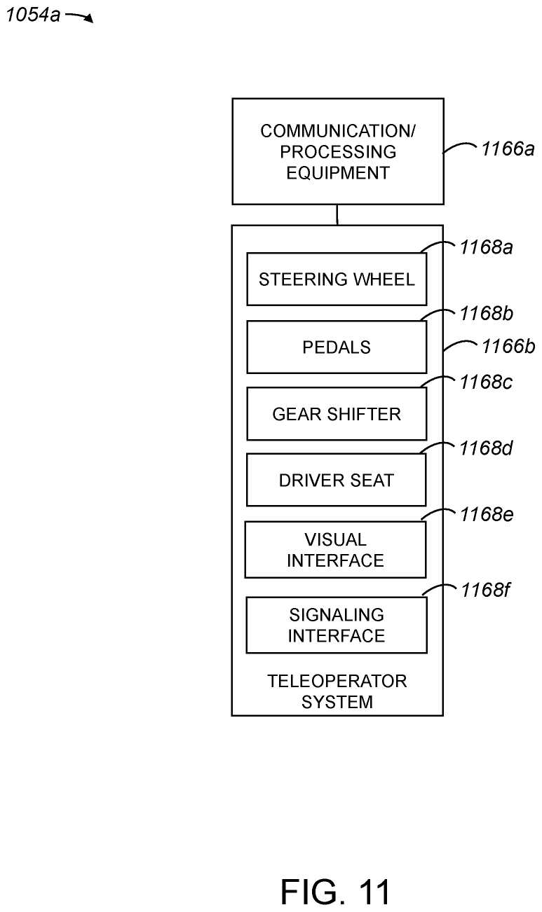

Teleoperations monitor arrangement 452 is arranged to enable a monitor, e.g., a human observer or a proctor, to monitor or to otherwise scrutinize the environments in which fleet 458 is operating. Teleoperations monitor arrangement 452 may generally enable multiple vehicles 401a-n to be monitored at substantially the same time. One example of a teleoperations monitor arrangement such as teleoperations monitor arrangement 452 will be discussed below with reference to FIG. 11.

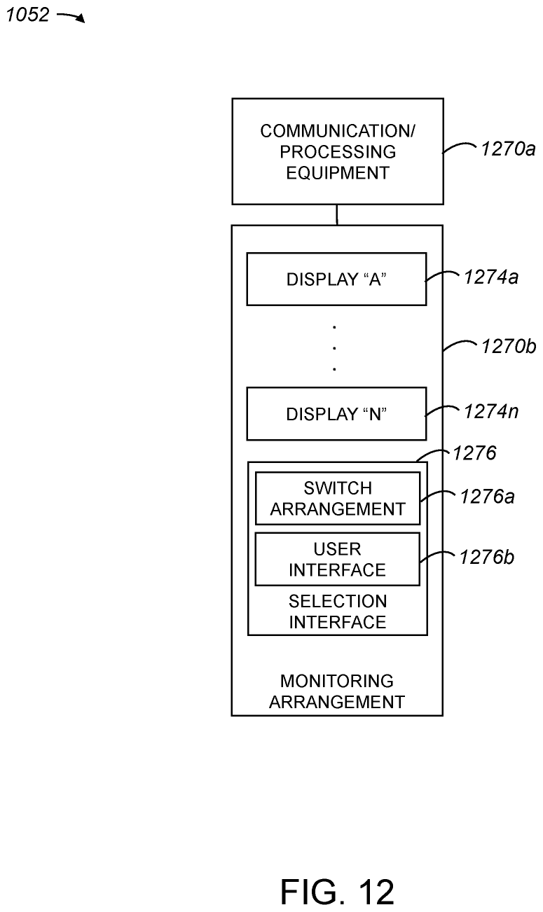

Teleoperations operator arrangements 454a-m are generally teleoperations operation stations which each include hardware and/or software which enable an operator, e.g., a human driver or controller, to operate one vehicle 401a-n at a time. That is, while teleoperations monitor arrangement 452 may monitor multiple vehicles 401a-n substantially simultaneously, each teleoperations operator arrangement 454a-m may be used to operate one vehicle 401a-n at a time. One example of a teleoperations operator arrangement such as teleoperations operator arrangement 454a-m will be discussed below with respect to FIG. 12.

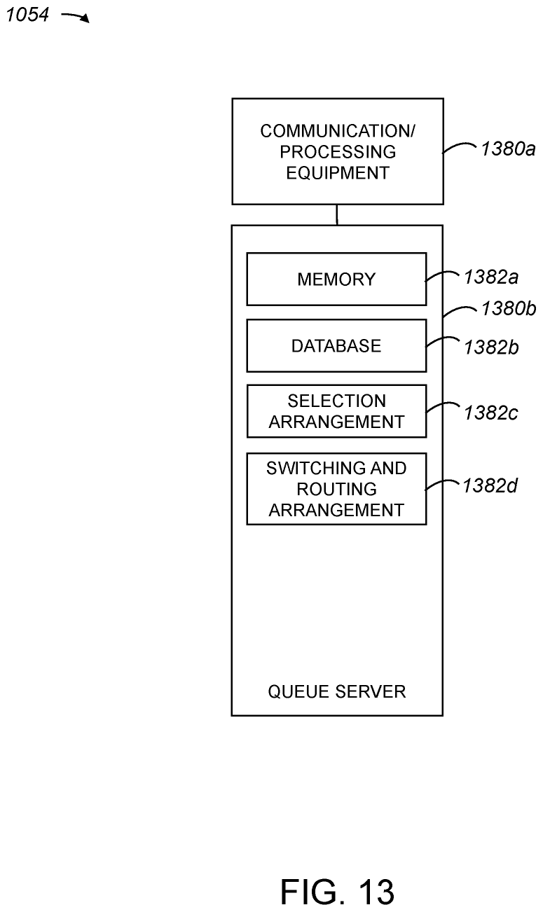

Teleoperations queue arrangement 456 is configured to identify any vehicles 401a-n which may benefit from, e.g., substantially require, assistance from one teleoperations operator arrangement 454a-m. In the described embodiment, teleoperations queue arrangement 456 may be populated by teleoperations monitor arrangement 452 when teleoperations monitor arrangement 452 identifies one of more vehicles 401a-n which has an issue that may be substantially mitigated by an operator using one teleoperations operator arrangement 454a-m. One example of a teleoperations queue arrangement such as teleoperations queue arrangement 456 will be discussed below with respect to FIG. 13.

The operation of platform 450 begins, at a time t1, when teleoperations monitor arrangement 452 monitors fleet 458 or, more specifically, one or more vehicles 401a-n in fleet 458 which are operating autonomously. At a time t2, teleoperations monitor arrangement 452 determines that vehicle “A” 401a may benefit from control provided by a teleoperations operator arrangement 454a-m. Such a determination may include, but is not limited to including, ascertaining that vehicle “A” 401a has encountered an issue such as a hardware issue or a software issue, ascertaining that vehicle “A” 401a is in a situation that vehicle “A” 401a is unable to navigate, and/or ascertaining that vehicle “A” 401a is confronted with an obstacle.

At a time t3, teleoperations monitor arrangement 452 effectively adds vehicle “A” 401a to a queue maintained by teleoperations queue arrangement 456. Teleoperations queue arrangement 456 may identify a suitable teleoperations operator arrangement 454a-m to substantially take control of vehicle “A” 401a. As such, at a time t4, teleoperations queue arrangement 456 identifies teleoperations operator arrangement 454m as suitable for substantially taking control of vehicle “A” 401a and causes transfer of control for vehicle “A” 401a to teleoperations operator arrangement 454m. At a time t5, teleoperations operator arrangement 454m effectively takes control of vehicle “A” 401a. In one embodiment, the transfer of control for vehicle “A” 401a may be accomplished by teleoperations operator arrangement 454m being notified by teleoperations queue arrangement 456 to take control of vehicle “A” 401a, and teleoperations operator arrangement 454m communicating with vehicle “A” 401a. When teleoperations operator arrangement 454m takes control of vehicle “A” 401a, teleoperations operator arrangement 454m may issue commands or instructions to vehicle “A” 401a and remotely operate, e.g., drive, vehicle “A” 401a.

A teleoperations monitoring and operations platform may, in one embodiment, enable a teleoperations monitor arrangement to substantially directly assign control of a vehicle to a teleoperations operator arrangement. That is, a platform may effectively bypass the use of a teleoperations queue arrangement.

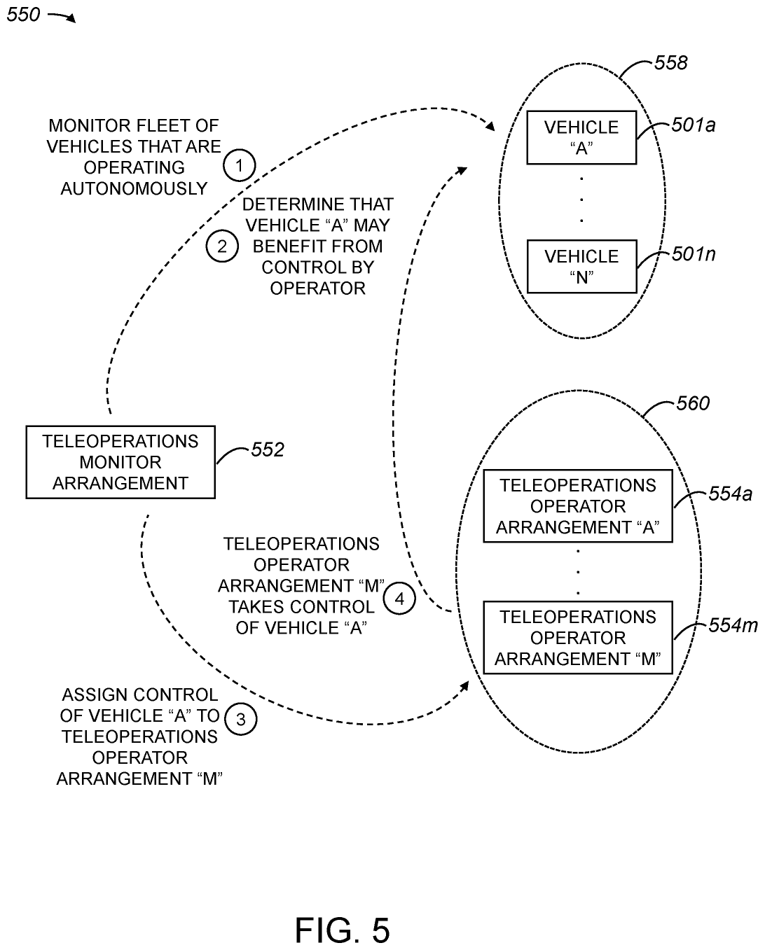

FIG. 5 is a diagrammatic representation of a teleoperations monitoring and operations platform which does not include a teleoperations queue arrangement in accordance with an embodiment. A teleoperations monitoring and operations platform 550 includes a fleet 558 of vehicles 501a-n which are capable of operating autonomously. Vehicles 501a-n may each generally include the components and functionality described above with respect to vehicle 101 of FIGS. 2 and 3. Platform 550 also includes at least one teleoperations monitor arrangement 552 configured to monitor fleet 558, and a group 560 of teleoperations operator arrangements 554a-m.

The operation of platform 550 begins, at a time t1, when teleoperations monitor arrangement 552 monitors fleet 558 or, more specifically, one or more vehicles 501a-n which are operating autonomously. At a time t2, teleoperations monitor arrangement 552 determines that vehicle “A” 501a may benefit from control provided by a teleoperations operator arrangement 554a-m. For example, teleoperations monitor arrangement 552 may identify a situation associated with vehicle “A” 501a which may be mitigated by a teleoperations operator arrangement 554a-m.

At a time t3 teleoperations monitor arrangement 552 may identify teleoperations operator arrangement 554m as suitable for substantially taking control of vehicle “A” 501a, and causes transfer of control for vehicle “A” 501a to teleoperations operator arrangement 554m. At a time t4, teleoperations operator arrangement 554m effectively takes control of vehicle “A” 501a. In one embodiment, the transfer of control for vehicle “A” 501a may be accomplished by teleoperations operator arrangement 554m being notified by teleoperations queue arrangement 556 to take control of vehicle “A” 501a, and teleoperations operator arrangement 554m communicating with vehicle “A” 501a. In one embodiment, the transfer of control may occur substantially only after teleoperations monitor arrangement 552 is able to effectively confirm that teleoperations operator arrangement 954m is available to take control of vehicle “A” 501a.

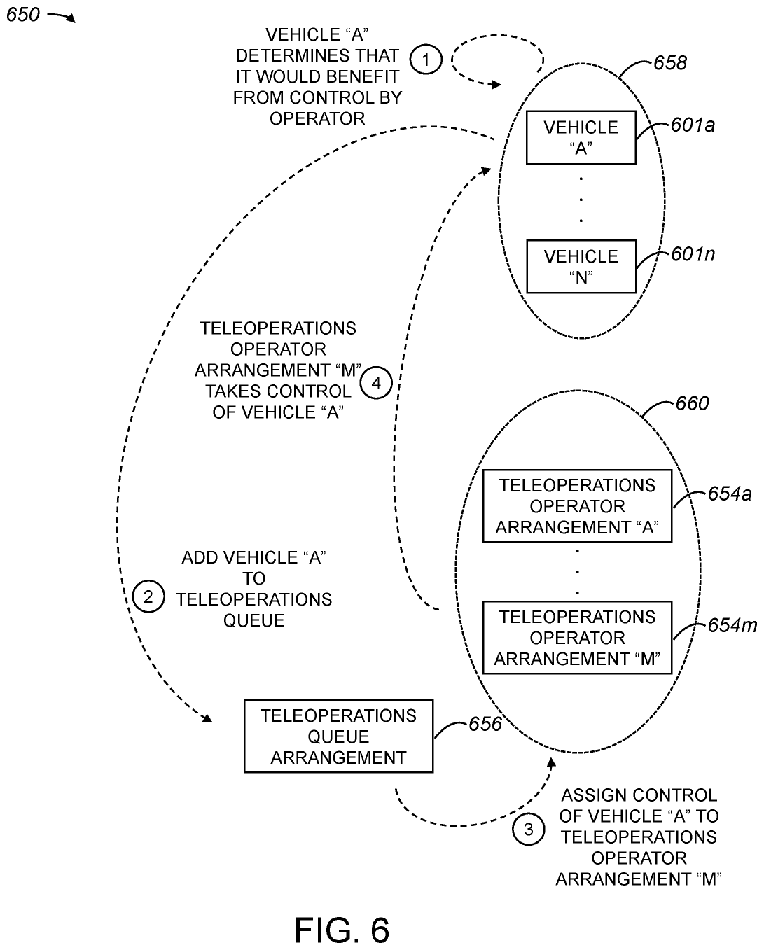

A platform may be configured as a teleoperations operations platform that includes a teleoperations queue arrangement, but does not include a teleoperations monitor arrangement. With reference to FIG. 6 a teleoperations operations platform which includes a teleoperations queue will be described in accordance with an embodiment. A teleoperations operations platform 650 includes a fleet 658 of vehicles 601a-n which are capable of operating autonomously, e.g., fully autonomously and/or semi-autonomously. Vehicles 601a-n may each generally include the components and functionality described above with respect to vehicle 101 of FIGS. 2 and 3. Platform 650 also includes a group 660 of teleoperations operator arrangements 654a-m, and a teleoperations queue arrangement 656. The number of teleoperations operator arrangements 654a-m and vehicles 601a-n may generally vary widely.

The operation of platform 650 begins, at a time t1, as vehicles 601a-n are operating and vehicle “A” 601a determines that vehicle “A” 601a would benefit from control by an operator of a teleoperations operator arrangement 654a-m. It should be understood that vehicles 601a-n may be self-monitoring in that each vehicle 601a-n may be configured to identify its own issues and to identify when a particular issue may essentially necessitate the use of a teleoperations operator arrangement 654a-m.

At a time t2, vehicle “A” 601a may effectively add itself to a queue managed by teleoperations queue arrangement 656. That is, vehicle “A” 601a may notify teleoperations queue arrangement 656 that control by a teleoperation operator arrangement 654a-m is requested. Once vehicle “A” 601a is effectively added to a queue maintained by teleoperations queue arrangement 656, teleoperations queue arrangement 656 may identify a suitable teleoperations operator arrangement 654a-m to essentially take control of vehicle “A” 601a. Thus, at a time t4, teleoperations operator arrangement 654m effectively takes control of vehicle “A” 601a.

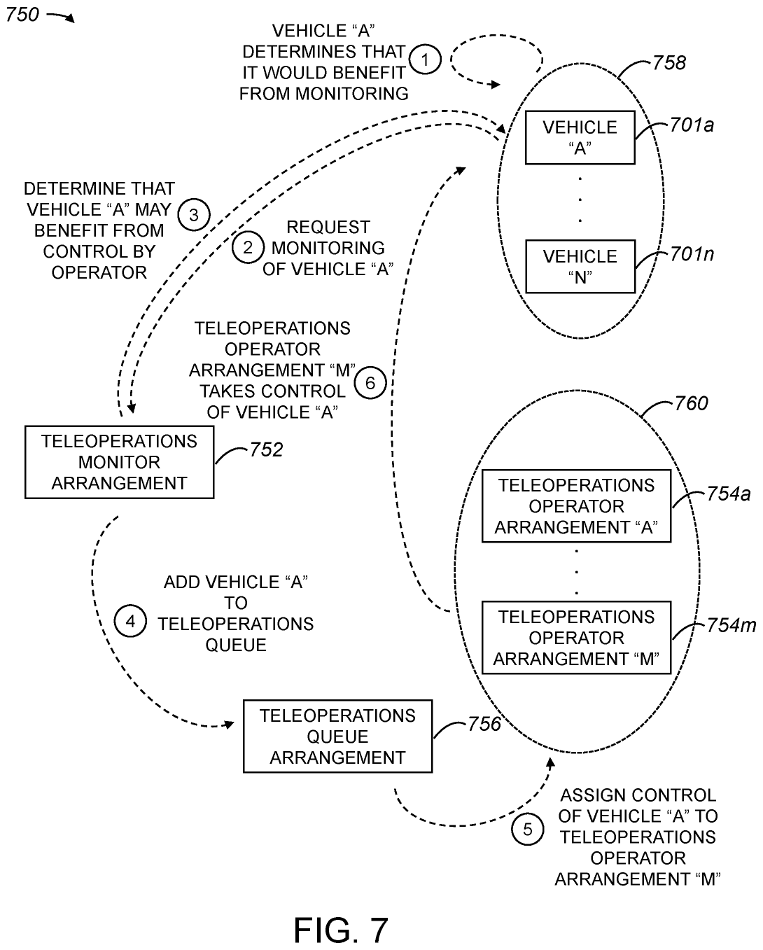

In one embodiment, a teleoperations monitoring and operations platform may, may include at least one teleoperations monitor arrangement and a teleoperations queue arrangement, and be configured to support a fleet of vehicles in which vehicles that are substantially self-monitoring. FIG. 7 is a diagrammatic representation of a teleoperations monitoring and operations platform which includes a teleoperations queue within which a vehicle of a fleet of vehicles may request teleoperations monitoring in accordance with an embodiment.

A teleoperations monitoring and operations platform 750 includes a fleet 758 of vehicles 701a-n which are capable of operating autonomously, a teleoperations monitor arrangement 752, a group 760 of teleoperations operator arrangements 754a-m, and a teleoperations queue arrangement 756. Vehicles 401a-n may each generally include the components and functionality described above with respect to vehicle 101 of FIGS. 2 and 3. The number of vehicles 401a-n included in fleet 458 may vary widely. In the described embodiment, vehicles 701a-n are substantially self-monitoring. That is, vehicles 701a-n may monitor themselves and request external monitoring from teleoperations monitor arrangement 752 if needed.

At a time t1, vehicle “A 701a, while self-monitoring or otherwise diagnosing issues it faces, determines that external monitoring by teleoperations monitor arrangement 752 is desired. As such, at a time t2, vehicle “A” 701a requests monitoring from teleoperations monitor arrangement 752. It should be appreciated that teleoperations monitor arrangement 752 may utilize a queue that prioritizes requests for monitoring.

Teleoperations monitor arrangement 752 begins monitoring vehicle “A” 701a and determines at a time t3 that vehicle “A” 701 may benefit from control by an operator using a teleoperations operator arrangement 754a-m. By way of example, after monitoring vehicle “A’ 701a, teleoperations operator arrangement 754a-m may identify an issue which may be mitigated using a teleoperations operator arrangement 754a-m.

At a time t4, teleoperations monitor arrangement 752 effectively adds vehicle “A” 701a to a queue maintained by teleoperations queue arrangement 756. Teleoperations queue arrangement 756 may identify a suitable teleoperations operator arrangement 754a-m to substantially take control of vehicle “A” 701a. At a time t5, teleoperations queue arrangement 756 identifies teleoperations operator arrangement 754m as suitable for substantially taking control of vehicle “A” 701a and causes transfer of control for vehicle “A” 701a to teleoperations operator arrangement 754m.

Teleoperations operator arrangement 754a takes control of vehicle “A” 701 at a time 6. When teleoperations operator arrangement 754m takes control of vehicle “A” 701a, teleoperations operator arrangement 754m may command vehicle “A” 701a to operate remotely.

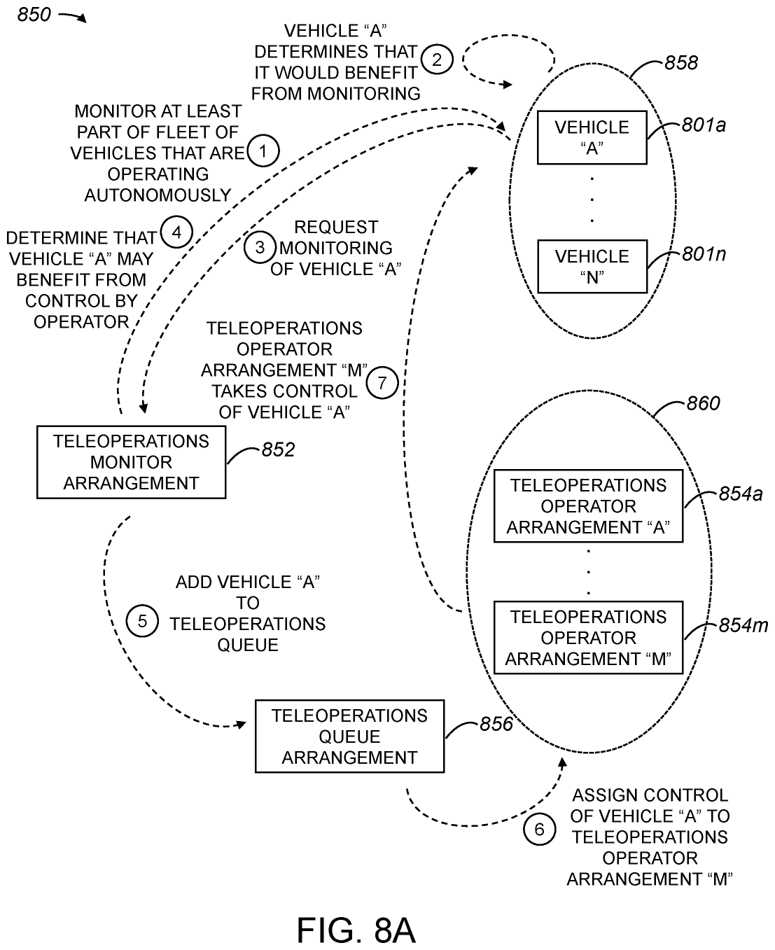

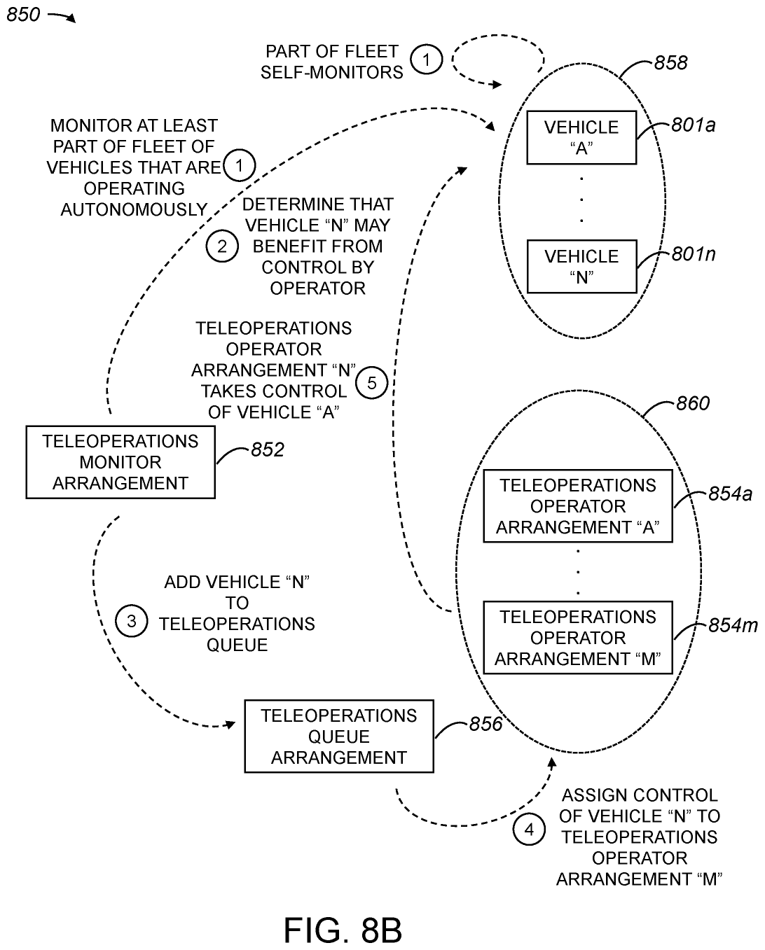

A fleet of vehicles may include some vehicles that are configured to self-monitor or to otherwise identify issues, as well as other vehicles that are configured to be monitored by a teleoperations monitor arrangement. In one embodiment, such a fleet of vehicles may be associated with a platform that includes a teleoperations queue arrangement. With respect to FIG. 8A, the identification of a potential issue may be identified by a self-monitoring vehicle and, with respect to FIG. 8B, the identification of a potential issue may be made by an externally monitored vehicle. FIG. 8A is a diagrammatic representation of a teleoperations monitoring and operations platform which includes a teleoperations queue within which a teleoperations monitor arrangement monitors at least a part of fleet of vehicles and the teleoperations monitor arrangement identifies a need for monitoring in accordance with an embodiment. A teleoperations monitoring and operations platform 850 includes a fleet 858 of vehicles 801a-n which are capable of operating autonomously, e.g., fully autonomously and/or semi-autonomously. Vehicles 801a-n may each generally include the components and functionality described above with respect to vehicle 101 of FIGS. 2 and 3. Within fleet 858, some vehicles 801a-n may be self-monitoring while other vehicles 801a-n may be externally monitored, e.g., monitored by a teleoperations monitor arrangement 852 of platform 850. Platform 850 also includes a group 860 of teleoperations operator arrangements 854a-m and a teleoperations queue arrangement 856.

The operation of platform 850 begins, at a time t1, when teleoperations monitor arrangement 852 monitors some vehicles 801a-n in fleet 458 while other vehicles in fleet 458 are self-monitoring. At a time t2, vehicle “A” 801a, while engaging in self-monitoring, determines that it would benefit from monitoring by teleoperations monitor arrangement 852. As a result, at a time t3, vehicle “A” 801a requests monitoring from teleoperations monitor arrangement 852.

Teleoperations monitor arrangement 852 begins monitoring vehicle “A” 801a in response to the request for external monitoring, and determines at a time t4 that vehicle “A” 801 may benefit from control by an operator using a teleoperations operator arrangement 854a-m. For example, after monitoring vehicle “A’ 801a, teleoperations operator arrangement 854a-m may identify an issue which may be mitigated using a teleoperations operator arrangement 854a-m. The identified issue may be the reason vehicle “A” 801a requested external monitoring.

At a time t5, teleoperations monitor arrangement effectively adds vehicle “A” 801a to a queue maintained by teleoperations queue arrangement 856. Teleoperations queue arrangement 856 may identify a suitable teleoperations operator arrangement 854a-m to substantially take control of vehicle “A” 801a. At a time t6, teleoperations queue arrangement 856 identifies teleoperations operator arrangement 854m as suitable for substantially taking control of vehicle “A” 801a and causes transfer of control for vehicle “A” 801a to teleoperations operator arrangement 854m.

Teleoperations operator arrangement 854a acquires control of vehicle “A” 801 at a time t7. When teleoperations operator arrangement 854m takes control of vehicle “A” 801a, teleoperations operator arrangement 854m may command vehicle “A” 801a to operate remotely.

As mentioned above, in lieu of a self-monitoring vehicle 801a-n with a potential issue requesting monitoring and subsequently being assigned a teleoperations operator arrangement 854a-m, an issue may instead be initially identified in externally monitored vehicle 801a-n by teleoperations monitor arrangement 852. Referring next to FIG. 8B, a process of responding to a vehicle 801a-n identified by teleoperations monitor arrangement 852 as essentially needing control by a teleoperations operator arrangement 854a-m will be described in accordance with an embodiment.

At a time t1, part of fleet 858 self-monitors while part of fleet 858 is monitored by teleoperations monitor arrangement 852. At a time t2, teleoperations monitor arrangement 852 determines that vehicle “N” 401n, which is not self-monitoring at times t1 or t2, may benefit from control provided by a teleoperations operator arrangement 854a-m. Such a determination may include, but is not limited to including, ascertaining that vehicle “N” 801n has encountered an issue which may prevent vehicle “N” from operating autonomously.

At a time t3, teleoperations monitor arrangement 852 effectively adds vehicle “N” 801n to a queue maintained by teleoperations queue arrangement 856. Teleoperations queue arrangement 856 may identify a suitable teleoperations operator arrangement 854a-m to substantially take control of vehicle “N” 801n. As such, at a time t4, teleoperations queue arrangement 856 identifies teleoperations operator arrangement 954m as suitable for substantially taking control of vehicle “N” 801n and causes transfer of control for ve8icle “A” 401a to teleoperations operator arrangement 454m. At a time t5, teleoperations operator arrangement 854m effectively takes control of vehicle “N” 801n.

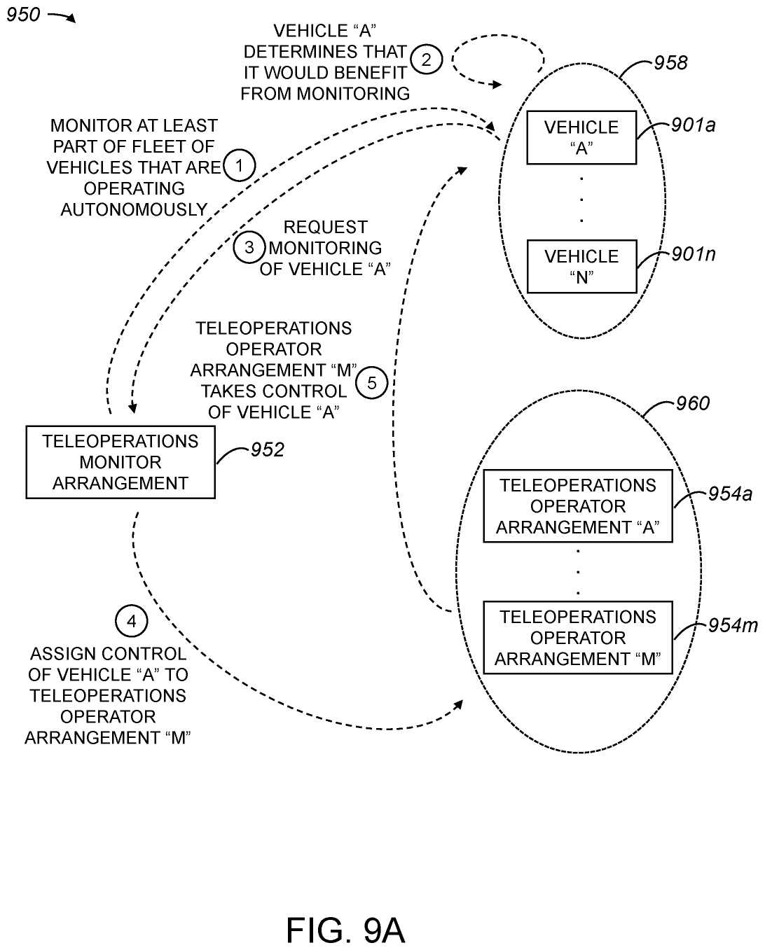

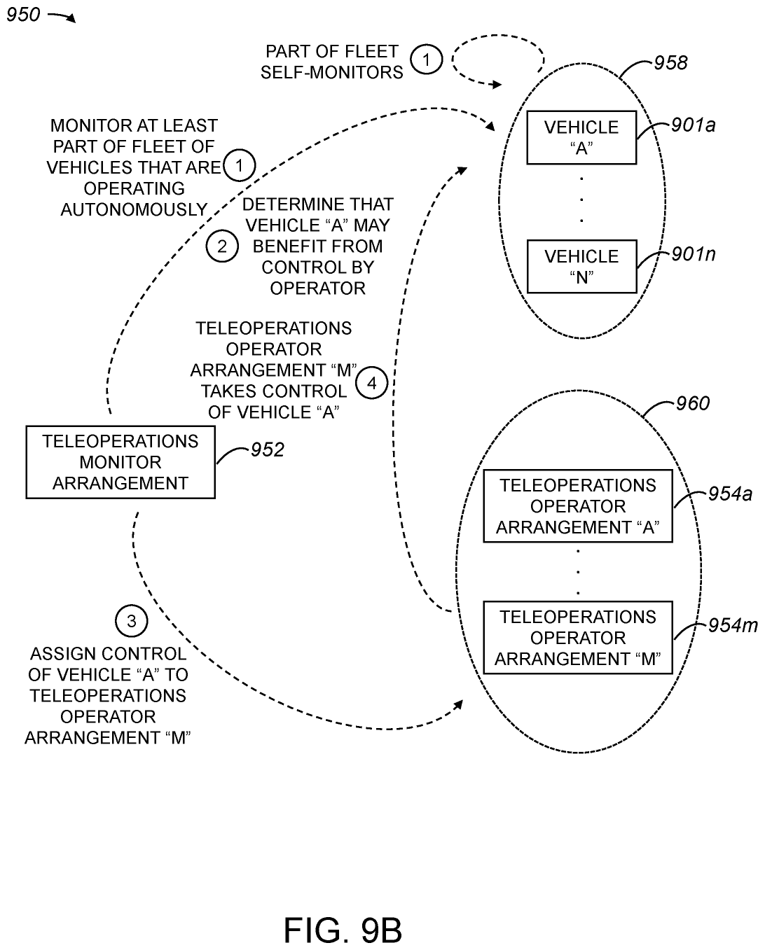

A platform that supports a fleet of vehicles may include some vehicles that are configured to self-monitor or to otherwise identify issues, as well as other vehicles that are configured to be monitored by a teleoperations monitor arrangement, may include a teleoperations queue arrangement as discussed above with respect to FIGS. 8A and 8B. Alternatively, a platform that supports a fleet of vehicles with both self-monitoring and externally monitored vehicles may not include a teleoperations queue arrangement. Such a platform will be described below with reference to FIGS. 9A and 9B.

FIG. 9A is a diagrammatic representation of a teleoperations monitoring and operations platform which does not include a teleoperations queue within which a teleoperations monitor arrangement monitors at least a part of fleet of vehicles and a self-monitoring vehicle identifies a need for monitoring in accordance with an embodiment. A teleoperations monitoring and operations platform 950 includes a fleet 958 of vehicles 901a-n which are capable of operating autonomously. Vehicles 901a-n may each generally include the components and functionality described above with respect to vehicle 101 of FIGS. 2 and 3. Platform 950 also includes at least one teleoperations monitor arrangement 952 configured to monitor at least some vehicles 901a-n included in fleet 958, and a group 960 of teleoperations operator arrangements 954a-m. It should be appreciated that any vehicles 901a-n which are not monitored by teleoperations monitor arrangement 952 may generally be self-monitoring.

The operation of platform 950 begins, at a time t1, when teleoperations monitor arrangement 952 monitors at least some vehicles 901a-n in fleet 958, while other vehicles 901a-n may be self-monitoring. In general, monitored vehicles 901a-n are operating autonomously.

At a time t2, vehicle “A” 901a, which is self-monitoring, determines that it would benefit from monitoring. In one embodiment, vehicle “A” 901a may identify an issue which vehicle “A” 901a for which an assessment by teleoperations monitor arrangement 952 may be prudent. As such, at a time t3, vehicle “A” 901a requests that teleoperations monitor arrangement 952 monitor vehicle “A” 901a.

At a time t4, teleoperations monitor arrangement 952 determines that vehicle “A” 901a may benefit from control provided by a teleoperations operator arrangement 954a-m. For example, teleoperations monitor arrangement 952 may observe the issue identified by vehicle “A” 901a and determine that the issue may be substantially mitigated by a teleoperations operator arrangement 954a-m. As such, teleoperations monitor arrangement 952 may identify teleoperations operator arrangement 954m as suitable for substantially taking control of vehicle “A” 901a, and may cause a transfer of control for vehicle “A” 901a to teleoperations operator arrangement 954m.

Teleoperations operator arrangement 954m effectively takes control of vehicle “A” 901a at a time t5. In one embodiment, the transfer of control for vehicle “A” 901a may be accomplished by teleoperations operator arrangement 954m being notified by teleoperations queue arrangement 956 to take control of vehicle “A” 901a, and teleoperations operator arrangement 954m communicating with vehicle “A” 901a.

Referring next to FIG. 9B, the operation of platform 950 when teleoperations monitor arrangement 952 ascertains that a vehicle 901a-n should be controlled by a teleoperations operator arrangement 954a-m in accordance with an embodiment. At a time t1, while vehicles 901a-n operate autonomously, teleoperations monitor arrangement 952 monitors at least some vehicles 901a-n of fleet 958, while other vehicles 901a-n of fleet 958 are self-monitoring.

At a time t2, teleoperations monitor arrangement 952 determines that vehicle “A” 901a, which is being monitored by teleoperations arrangement 952, may benefit from control by a teleoperations operator arrangement 954a-m. Then, at a time t3, teleoperations monitor arrangement 952 assigns control of vehicle “A” 901a to teleoperations operator arrangement 954m. Teleoperations operator arrangement 954m takes control of vehicle “A” 901a at a time t4.

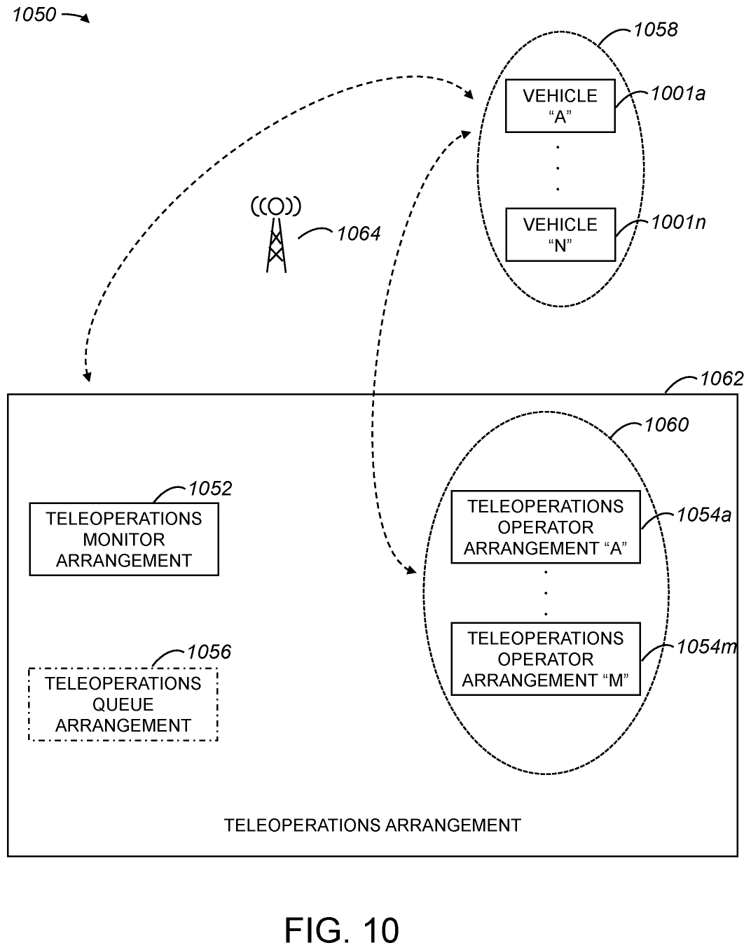

In general, communications within a platform which supports teleoperations and a fleet, as for example a teleoperations monitoring and operations platform as described above, may be supported by any suitable network. For example, communications may be supported by a wireless network such as a cellular network and/or a 3G/4G/5G network. FIG. 10 is a diagrammatic representation of a teleoperations monitoring and operations platform which shows communications between vehicles and an overall teleoperations arrangement in accordance with an embodiment. A platform 1050 generally includes a fleet 1058 and a teleoperations arrangement 1062. Fleet 1058 which includes vehicles 1001a-n which are capable of operating autonomously.

Teleoperations arrangement 1062 includes a teleoperations monitor arrangement 1052 and an optional teleoperations queue arrangement 1056. Teleoperations arrangement 1062 also includes a set 1060 that includes at least one teleoperations operator arrangement 1054a-m.

Communications within teleoperations arrangement 1062 may include wired and wireless communications. Communications between vehicles 1001a-n in fleet 1058 and teleoperations arrangement 1062 occur using a network 1064. Network 1064 may be, but is not limited to being, a wireless network such as a cellular network, an IOS network, an LTE network, and/or a 3G/4G/5G network.

FIG. 11 is a block diagram representation of a teleoperations operator arrangement, e.g., teleoperations operator arrangement 1054a of FIG. 10, in accordance with an embodiment. As shown in FIG. 11, teleoperations operator arrangement 1054a may include communication/processing equipment 1166a and teleoperator or human operator system 1166b which are in communication with each other. Communication/processing equipment 1166a may be arranged to receive or to otherwise obtain signals from a vehicle across a network. Signals may be processed by communications/processing equipment 1166a to provide information that enables teleoperations operator arrangement 1054a to operate the vehicle remotely. Communication/processing equipment 1166a may also send or otherwise provide signals to the vehicle, as for example signals that include instructions to operate the vehicle.

Teleoperator or human operator system 1166b generally includes controls and other equipment which enable a remote human to drive or to otherwise control a vehicle. Teleoperator or human operator system 1166b may generally include a steering wheel 1168a, pedals 1168b, a gear shifter 168c, a driver set 1168d, a visual interface 168e, and a signaling interface 1168f.

Pedals 1168b may include an accelerator pedal, e.g., a gas pedal, and a brake. Visual interface 1168e may, in one embodiment, include at least one display screen arranged to display images which substantially depict the environment around a vehicle controlled using teleoperations operator arrangement 1054a.

Signaling interface 1168f is configured to enable information obtained from a teleoperations monitoring arrangement and/or a teleoperations queue arrangement, e.g., teleoperations monitoring arrangement 1052 and/or teleoperations queue arrangement 1056 of FIG. 10, to be processed. Processing information from a teleoperations monitoring arrangement and/or a teleoperations queue arrangement includes, but is not limited to including, identifying a vehicle that teleoperations operator arrangement 1054a is to take control of and/or identifying which teleoperations monitoring arrangement is effectively assigning the vehicle to teleoperations operator arrangement 1054a. Signaling interface 1168f may also enable teleoperations operator arrangement 1054a to effectively notify a teleoperations monitor arrangement, as for example using communication/processing equipment 1166a, and/or a teleoperations queue arrangement when teleoperations operator arrangement 1054a takes control of a vehicle.

FIG. 12 is a block diagram representation of a teleoperations monitor arrangement, e.g., teleoperations monitor arrangement 1052 of FIG. 10, in accordance with an embodiment. Teleoperations monitor arrangement 1052 includes communication/processing equipment 1270a and a monitoring arrangement 1270b. Communication/processing equipment 1270a may be arranged to receive or to otherwise obtain signals from a vehicle across a network, and to send or to otherwise provide signals to the vehicle across the network. Further, communication/processing equipment 1170a may also obtain signals from and/or provide signals to a teleoperations queue arrangement and/or a teleoperations operator arrangement, e.g., teleoperations queue arrangement 1056 and/or teleoperations operator arrangement 1054a of FIG. 10.

Monitoring arrangement 1270b includes one or more displays 1274a-n and a selection interface 1676b. Each display 1274a-n may display at least one image or scene associated with a vehicle that is being monitored using teleoperations monitor arrangement 1252. Alternatively, more than one display 1274a-n may be associated with a single vehicle. That is, a single display 1274a-n may be configured to provide different views associated with a vehicle, or multiple displays 1274a-n may be configured to display information, as for examples images or views, associated with a particular vehicle.

Selection interface 1276 generally enables teleoperations monitor arrangement 1052 to select vehicles to monitor and, in one embodiment, to select a teleoperations operator arrangement to monitor a specific vehicle. Selection interface 1276 includes a switch arrangement 1276a and a user interface 1276b. Switch arrangement 1276a may enable inputs associated with multiple vehicles, queues, and/or teleoperations operator arrangements to be provided to teleoperation monitor arrangement 1052, and user interface 1276b may enable a monitor to interact with teleoperation monitor arrangement 1052 to select which vehicles. queues, and/or teleoperations operator arrangements to interact with.

FIG. 13 is a block diagram representation of a teleoperations queue arrangement, e.g., teleoperations queue arrangement 1056 of FIG. 10, in accordance with an embodiment. Teleoperations queue arrangement 1054 includes communication/processing equipment 1380a and a queue server 1380b. Communication/processing equipment 1380a may be arranged to receive or to otherwise obtain signals from a vehicle or from a teleoperations monitor arrangement such as teleoperations monitor arrangement 1052 of FIG. 10, and to send or to otherwise provide signals to the vehicle or to the teleoperations monitor arrangement across the network. Further, communication/processing equipment 1380a may also obtain signals from and/or provide signals to a teleoperations operator arrangement, e.g., teleoperations operator arrangement 1054a of FIG. 10.

Queue server 1380b includes a memory 1382a, a database 1382b, a selection arrangement 1382c, and a switching and routing arrangement 1382d. Memory 1382a may be configured to support a queue or vehicles which are awaiting assignment of a teleoperations operator arrangement. That is, information relating to vehicles which are queued and awaiting assignment to a teleoperations operator arrangement may be stored in memory 1382a. Database 1382b may include information associated with vehicles and teleoperations operator arrangements that may facilitate the assignment of a particular teleoperations operator arrangement to a particular vehicle. For example, database 1382b may include profiles of different operators.

Selection arrangement 1382c is configured to enable queue server 1380b to select an appropriate teleoperations operator arrangement to service a particular vehicle that is queued and awaiting assignment of a teleoperations operator arrangement. Switching and routing arrangement 1382d is configured to facilitate a process of notifying a particular teleoperations operator arrangement of an assignment to take control of a particular vehicle, notifying the particular vehicle that it is to be controlled by the particular teleoperations operator arrangement, and/or notifying a teleoperations monitor arrangement that the particular teleoperations operation arrangement is to take control of the particular vehicle.

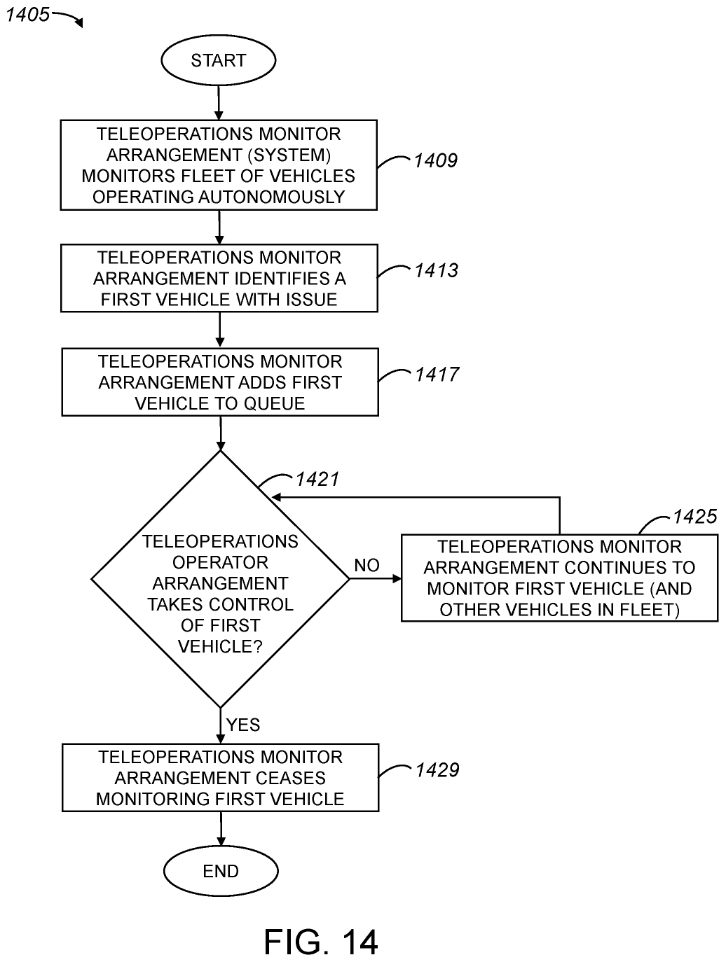

FIG. 14 is a process flow diagram which illustrates a method of enabling a teleoperations operator to assume responsibility for operating a vehicle when a platform supports monitoring and at least one queue in accordance with an embodiment. A process 1405 of enabling a teleoperations operator to take responsibility for operating a vehicle begins at a step 1405 in which a teleoperations monitor system or arrangement monitors a fleet of vehicles that are operating autonomously in a step 1409. That is, a teleoperations monitor arrangement observes one or more vehicles which are operating autonomously.

In a step 1413, the teleoperations monitor arrangement identifies a first vehicle with an issue. The issue may generally be a situation or condition which may interfere with an ability for the first vehicle to safely operate in an autonomous mode. Once the teleoperations monitor arrangement identifies the issue, the teleoperations monitor arrangement adds the first vehicle to a queue, e.g., a queue of vehicles which are awaiting assignment to teleoperations operator arrangements which may take control of the vehicles, in a step 1417.

A determination is made in a step 1421 as to whether the teleoperations operator arrangement has taken over or otherwise assumed control of the first vehicle. That is, it is determined whether the teleoperations monitor arrangement has identified a teleoperations operator arrangement to take control of the first vehicle and whether that teleoperations operator arrangement has taken control of the first vehicle.

If it is determined in step 1421 that the teleoperations operator arrangement has not taken control of the first vehicle, then in a step 1425, the teleoperations monitor arrangement continues to monitor the first vehicle as well as other vehicles in the fleet. While monitoring other vehicles in the fleet, the teleoperations monitor arrangement continues to identify any issues associated with the other vehicles. Process flow returns from step 1425 to step 1421 in which it is determined whether the teleoperations operator arrangement has taken control of the first vehicle.

Alternatively, if it is determined in step 1421 that the teleoperations operator arrangement has taken control of the first vehicle, the implication is that responsibility for operating the first vehicle has been substantially assumed by the teleoperations operator arrangement. Accordingly, in a step 1429, the teleoperations monitor arrangement ceases monitoring the first vehicle, and the process of enabling a teleoperations operator to take responsibility for operating a vehicle is completed.

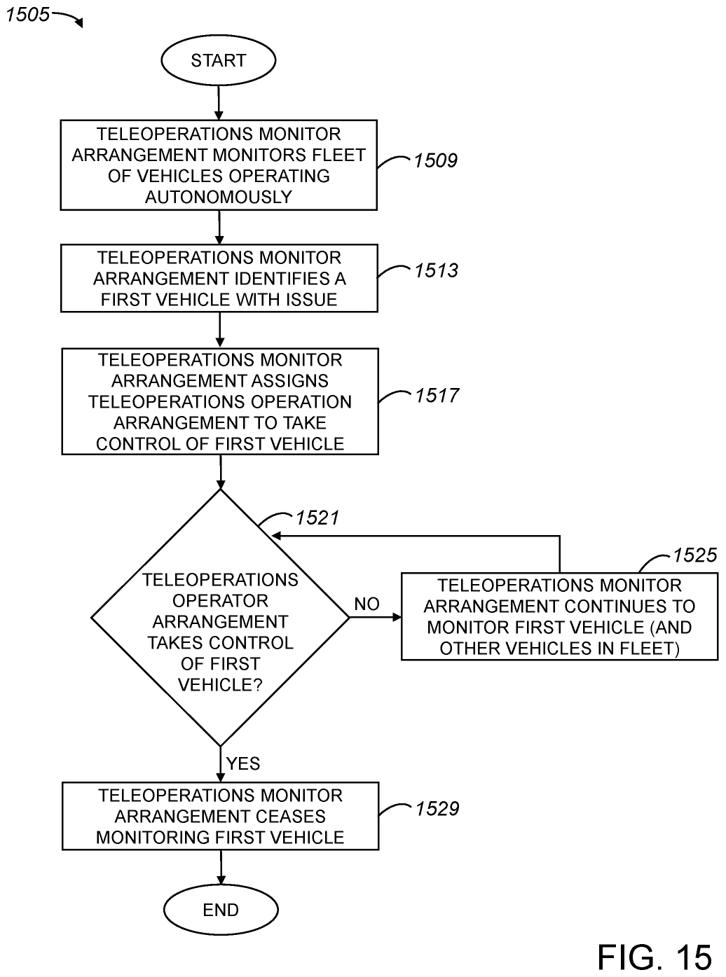

FIG. 15 is a process flow diagram which illustrates a method of enabling a teleoperations operator to assume responsibility for operating a vehicle when a platform supports monitoring in accordance with an embodiment. A process 1505 of enabling a teleoperations operator to take responsibility for operating a vehicle begins at a step 1505 in which a teleoperations monitor system or arrangement monitors a fleet of vehicles that are operating autonomously in a step 1509.

In a step 1513, the teleoperations monitor arrangement identifies a first vehicle with an issue. The issue may generally be a problem or a potential problem which may affect the ability for the first vehicle to operate autonomously in a safe manner. Once the teleoperations monitor arrangement identifies the issue, the teleoperations monitor arrangement identifies, and effectively assigns, a suitable teleoperations operation arrangement to take control of the first vehicle in a step 1517.

A determination is made in a step 1521 as to whether the teleoperations operator arrangement has taken over or otherwise assumed control of the first vehicle. If it is determined that the teleoperations operator arrangement has not taken control of the first vehicle, then in a step 1525, the teleoperations monitor arrangement continues to monitor the first vehicle as well as other vehicles in the fleet. Process flow returns from step 1525 to step 1521 in which it is determined whether the teleoperations operator arrangement has taken control of the first vehicle.

Alternatively, if it is determined in step 1521 that the teleoperations operator arrangement has taken control of the first vehicle, the implication is that responsibility for operating the first vehicle has been substantially assumed by the teleoperations operator arrangement. As such, in a step 1529, the teleoperations monitor arrangement ceases monitoring the first vehicle, and the process of enabling a teleoperations operator to take responsibility for operating a vehicle is completed.

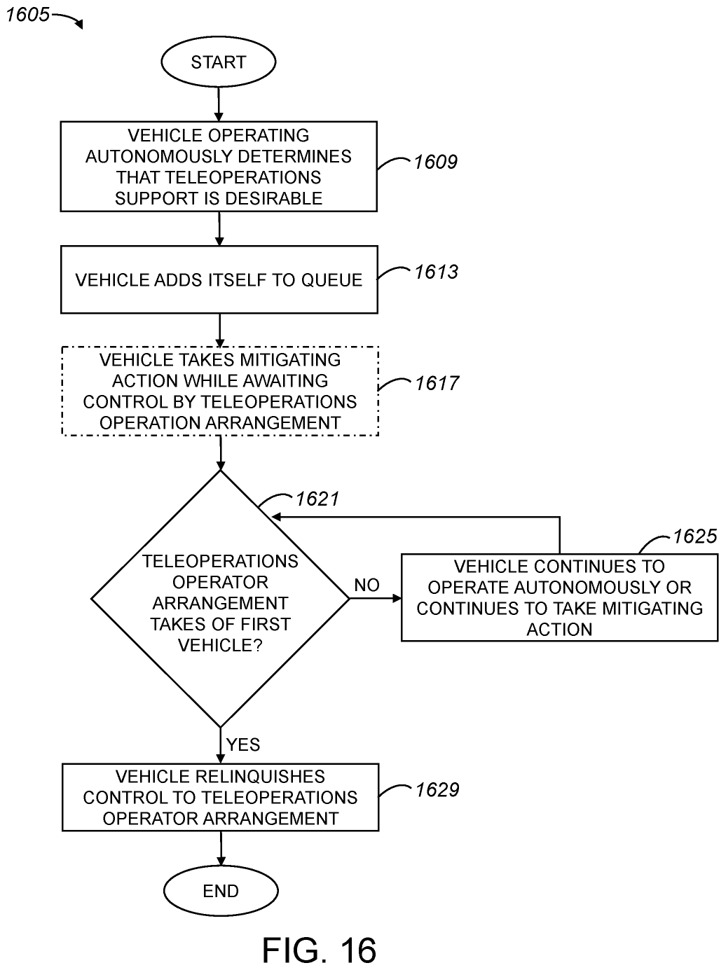

Referring next to FIG. 16, a method of enabling a teleoperations operator to assume responsibility for operating a vehicle when a platform supports queues, and does not include a teleoperations monitor arrangement, will be described in accordance with an embodiment. A process 1605 of enabling a teleoperations operator to take responsibility for operating a vehicle begins at a step 1605 in which a vehicle that is operating autonomously determines, as for example through self-monitoring, that teleoperations support is desirable. The vehicle may determine that there is an issue or a potential issue which may be mitigated through teleoperations support provided by a teleoperations operator arrangement.

In a step 1613, the vehicle effectively adds itself to a queue, as for example a queue managed or otherwise maintained by a teleoperations queue arrangement, Then, in a step 1617, the vehicle may optionally take a mitigation action while awaiting control by a teleoperations operator arrangement. For example, the vehicle may optionally pull over or otherwise stop while awaiting control by a teleoperations operation arrangement.

It is determined in a step 1621 whether the teleoperations operator arrangement has taken over or otherwise assumed control of the vehicle. If the determination is that the teleoperations operator arrangement has not taken control of the vehicle, then in a step 1625, the vehicle continues to operate autonomously or continues to take mitigating action. Process flow returns from step 1625 to step 1621 in which it is determined whether the teleoperations operator arrangement has taken control of the vehicle.

Alternatively, if it is determined in step 1621 that the teleoperations operator arrangement has taken control of the vehicle, the implication is that responsibility for operating the vehicle has been substantially assumed by the teleoperations operator arrangement. Accordingly, in a step 1629, the vehicle effectively relinquishes control of itself, and allows the teleoperations operator arrangement to take control. The process of enabling a teleoperations operator to take responsibility for operating a vehicle is completed when the vehicle relinquishes control to a teleoperations operator arrangement.

In one embodiment, a teleoperations monitor arrangement does not actively monitor one or more autonomous vehicles, but responds to requests from a vehicle to engage in monitoring. That is, an autonomous vehicle may effectively be self-monitoring, and may be arranged to request monitoring from a teleoperations monitor arrangement when the autonomous vehicle determines that monitoring from a teleoperations monitor arrangement is desirable. For example, the autonomous vehicle may identify a potential issue and request monitoring from a teleoperations monitor arrangement to determine whether the potential issue is an issue that is to be handled by a teleoperator. The ability for an autonomous vehicle to monitor itself, or to self-monitor, enables a teleoperators monitor to effectively remain on call but to substantially refrain from actively monitoring the autonomous vehicle unless the autonomous vehicle requests monitoring.

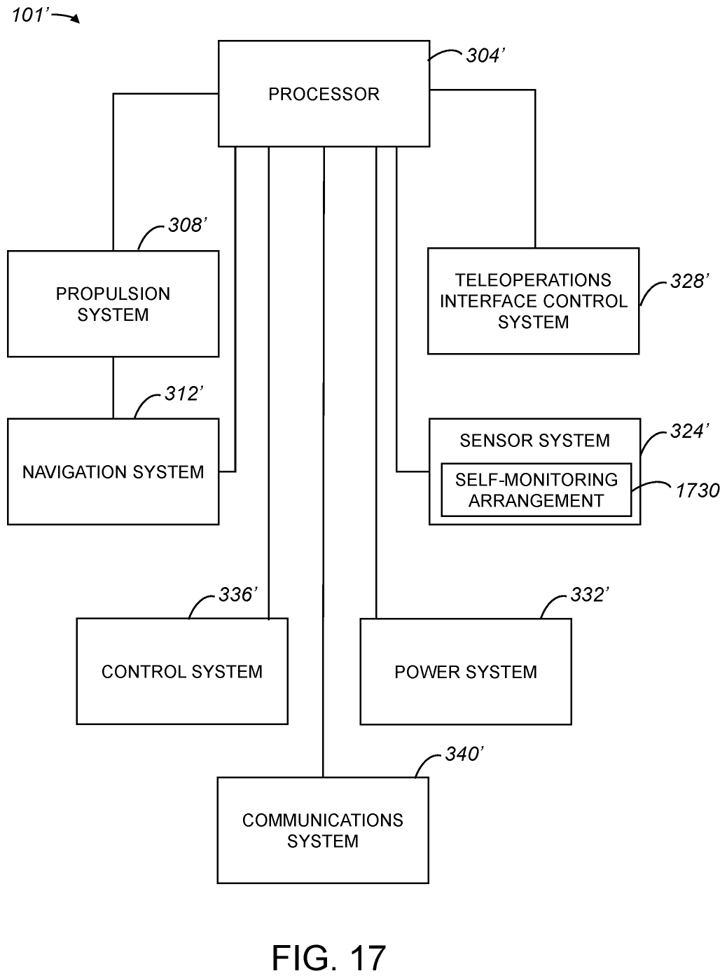

FIG. 17 is a block diagram representation of an autonomous vehicle, e.g., autonomous vehicle 101 of FIGS. 1-3, that includes a self-monitoring arrangement in accordance with an embodiment. An autonomous vehicle 101′ includes a processor 304′, a propulsion system 308′, a navigation system 312′, a sensor system 324′, a teleoperations interface control system 328′, a power system 332′, a control system 336′, and a communications system 340′. It should be appreciated that the functionality of processor 304′, propulsion system 308′, navigation system 312′, sensor system 324′, teleoperations interface control system 328′, power system 332′, control system 336′, and communications system 340′ is similar to the functionality of the systems on autonomous vehicle 101 as described above with respect to FIG. 3.

In one embodiment, sensor system 324′ is configured to enable autonomous vehicle 101′ to identify an issue or a potential issue which may effectively necessitate control of autonomous vehicle 101′ remotely. A self-monitoring arrangement 1730 of sensor system 324′ may generally enable autonomous vehicle 101′ to monitor itself and/or its surroundings to determine if there are any issues or potential issues which may have an effect on the autonomous operation of autonomous vehicle 101′.

As discussed above with respect to FIG. 3, teleoperations interface control system 328′ generally enables vehicle 101′ to be controlled remotely, as for example by a teleoperations operator arrangement. That is, teleoperations interface control system 328′ enables vehicle 101′ to operate by obtaining and processing instructions provided by a teleoperations operator arrangement. Additionally, teleoperations interface control system 328′ may enable vehicle 101′ to determine when vehicle 101′, while operating autonomously, may benefit from being controlled via teleoperations and to request remote monitoring and/or control by a teleoperator. In one embodiment, teleoperations interface control system 328′ enables vehicle 101′ to communicate with a teleoperations monitor arrangement, a teleoperations operator arrangement, and/or a teleoperations queue.

As will be appreciated by those skilled in the art, when autonomous vehicle 101” operates autonomously, vehicle 101′ may generally operate, e.g., drive, under the control of an autonomy system. That is, when autonomous vehicle 101′ is in an autonomous mode, autonomous vehicle 101′ is able to generally operate without a driver or a remote operator controlling autonomous vehicle. In one embodiment, autonomous vehicle 101′ may operate in a semi-autonomous mode or a fully autonomous mode. When autonomous vehicle 101′ operates in a semi-autonomous mode, autonomous vehicle 101′ may operate autonomously at times and may operate under the control of a driver or a remote operator at other times. When autonomous vehicle 101′ operates in a fully autonomous mode, autonomous vehicle 101′ typically operates substantially only under the control of an autonomy system. The ability of an autonomous system to collect information and extract relevant knowledge from the environment provides autonomous vehicle 101′ with perception capabilities. For example, data or information obtained from sensor system 324′ may be processed such that the environment around autonomous vehicle 101′ may effectively be perceived.

A teleoperations monitoring and operations platform may generally include a fleet of vehicles which are capable of operating autonomously and remotely, e.g., through teleoperations, at least one monitor system which enables multiple vehicles to be monitored substantially simultaneously, and one or more teleoperations systems which enable vehicles to be teleoperated. In one embodiment, a monitor system may be configured to enable multiple vehicles to request supervision by the monitor system. Such requests may be queued such that the monitor system selects a request to service from the queue. It should be appreciated that supervisory requests may be serviced in any suitable order, as for example based on a first-in-first-out order or an order based on criticalities associated with the requests.

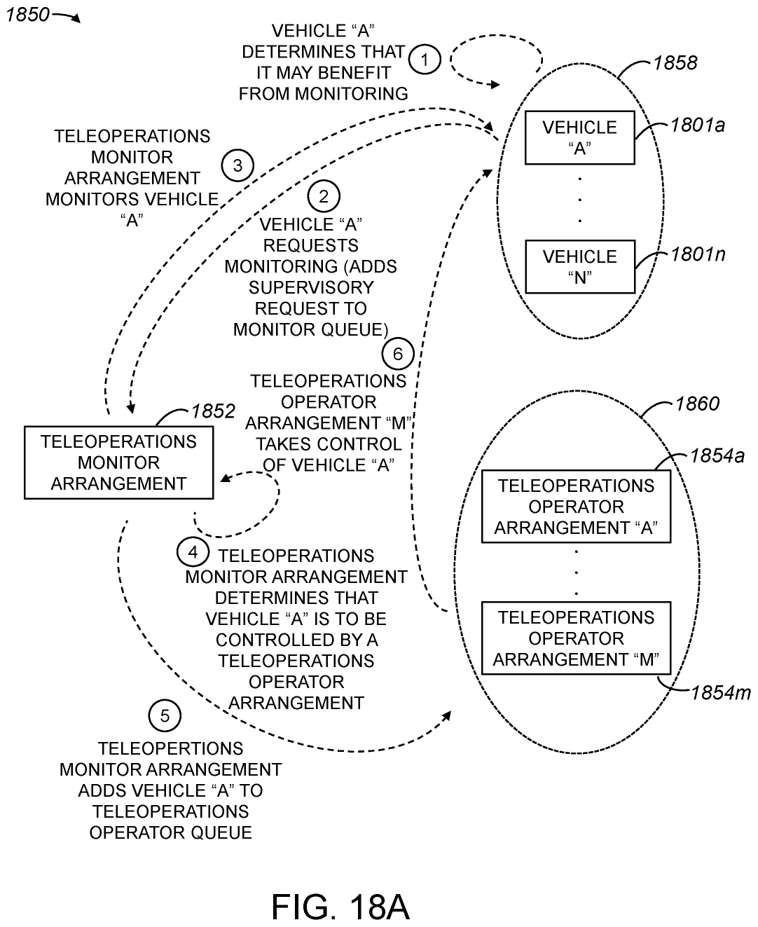

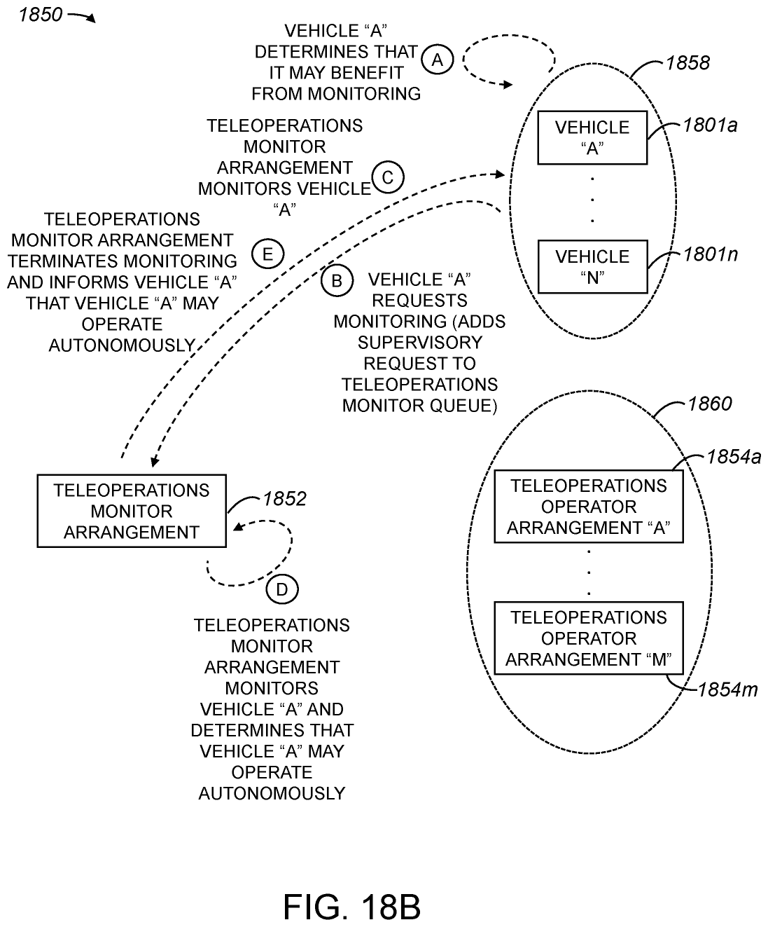

With reference to FIGS. 18A and 18B, a teleoperations monitoring and operations platform which includes at least one self-monitoring vehicle configured to request monitoring will be described in accordance with an embodiment, FIG. 18A is a diagrammatic representation of a teleoperations monitoring and operations platform which includes a self-monitoring vehicle configured to request monitoring when monitoring effectively uncovers a need for a teleoperations operator arrangement to remotely control the self-monitoring vehicle in accordance with an embodiment. A platform 1850 includes a teleoperations monitor arrangement 1852, a fleet 1858 of vehicles 1801a-n which may operate autonomously or under remote control, and a teleoperations systems 1860 which include teleoperations operator arrangements 1854a-m. Teleoperations monitor arrangement 1852 may monitor one or more vehicles 1801a-n upon request by vehicles 1801a-n.

Vehicles 1801a-n may each be configured to perform self-monitoring to identify existing issues, imminent issues, and/or potential issues. By way of example, vehicle “A” 1801a may monitor itself, identify an issue or a concern, and determine that monitoring by teleoperations monitor arrangement 1852 may be prudent or otherwise appropriate. In one embodiment, self-monitoring may identify situations which may be predetermined to indicate that monitoring by teleoperations monitor arrangement 1852 is desirable. For instance, when vehicle “A” 1801a is at the beginning of a delivery mission or at the end of a delivery mission, vehicle “A” 1801a may substantially automatically generate a supervisory request to teleoperations monitor arrangement 1852.

At a time t1, vehicle “A” 1801a may determine that it may benefit from being monitored by teleoperations monitor arrangement 1852. At a time t2, vehicle “A” 1801a requests monitoring from teleoperations monitor arrangement 1852. Such a request may be accomplished, for example, by vehicle “A” 1801a generating a supervisory request and adding the supervisory request to a queue maintained by teleoperations monitor arrangement 1852. Upon obtaining the request for monitoring, teleoperations monitor arrangement 1852 monitors vehicle “A” 1801a at a time t3. Monitoring vehicle “A 1801a may include, but is not limited to including, teleoperations monitor arrangement 1852 obtaining and displaying diagnostic information about vehicle “A” 1801a, teleoperations monitor arrangement 1852 obtaining and displaying views associated with vehicle “A” 1801a, and/or teleoperations monitor arrangement 1852 obtaining information relating to conditions that may be encountered by vehicle “A” 1801 if vehicle “A” 1801a continues on its planned route.

As teleoperations monitor arrangement 1852 monitors vehicle “A” 1801a, teleoperations monitor arrangement 1852 may, at a time t4, determine that any issues faced by vehicle “A” 1801a are to be mitigated by allowing a teleoperations operator arrangement 1854a-m to remotely control vehicle “A” 1801a. As such, at a time t5, teleoperations monitor arrangement 1852 adds vehicle “A” 1801a to a queue associated with teleoperations system 1860. Such a queue may be used to assign one of teleoperations operator arrangements 1854a-n to remotely control vehicle “A” 1801a. At a time t5, teleoperations operator arrangement “M” 1854m is assigned to take control of vehicle “A” 1801a, and takes control of vehicle “A” 1801a.

In some situations, when a vehicle such as vehicle “A’ 1801a requests monitoring, a monitoring process may result in vehicle “A” 1801a continuing to operate autonomously substantially without intervention from a teleoperations system such as teleoperations system 1860. FIG. 18B is a diagrammatic representation of a teleoperations monitoring and operations platform 1850 when vehicle “A” 1801a requests monitoring and continues to operate autonomously after a monitoring process in accordance with an embodiment. At a time tA, while operating substantially autonomously and self-monitoring, vehicle “A’ 1801a determines that it may benefit from monitoring performed by teleoperations monitor arrangement 1852.

At a time tB, vehicle “A” 1801 requests monitoring from teleoperations monitor arrangement 1852, as for example by adding a supervisory request to a queue maintained by teleoperations monitor arrangement 1852. Teleoperations monitor arrangement 1852 begins monitoring vehicle “A” 1801a and a time tC. At a time tD, teleoperations monitor arrangement 1852 determines that vehicle “A” 1801 may safely operate autonomously, and effectively that it is not necessary to engage teleoperations operator system 1860. Teleoperations monitor arrangement 1852 terminates monitoring of vehicle “A” 1801a at a time tE, informs or otherwise notifies vehicle “A” 1801a that the supervisory request has been completed, and informs vehicle “A” 1801a that vehicle “A” 1801a may operate autonomously.

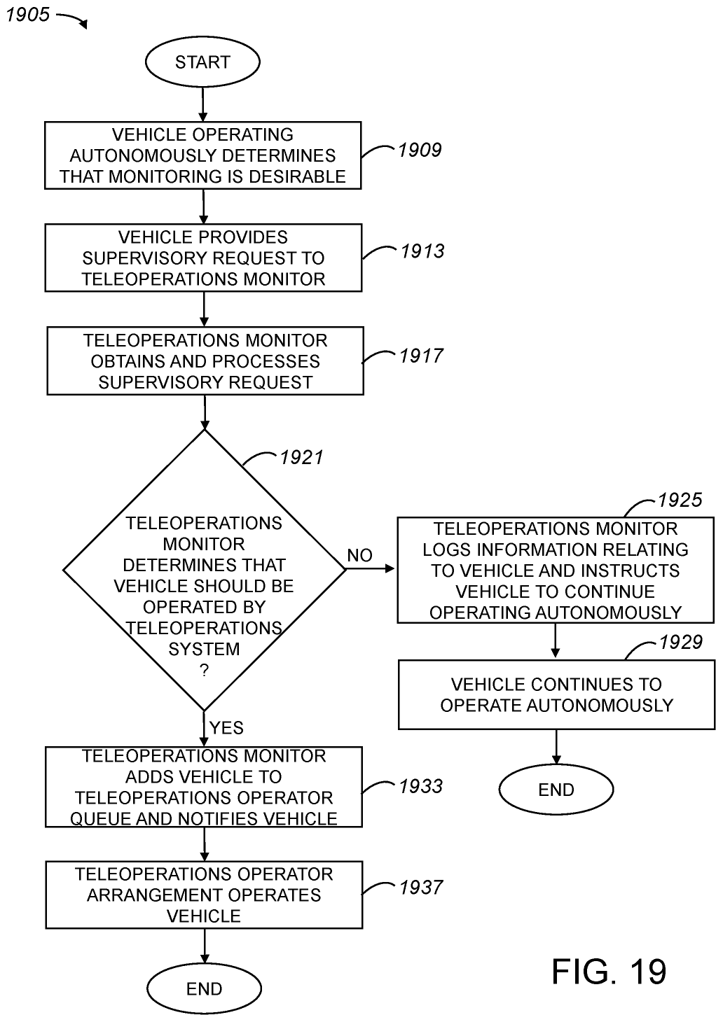

With reference to FIG. 19, a method of operating a teleoperations monitoring and operations platform will be described in accordance with an embodiment. A method 1905 of operating a teleoperations monitoring and operations platform begins at a step 1909 in which a vehicle that is operating autonomously determines that monitoring by a teleoperations monitor arrangement is desirable. The vehicle may make such a determination, for example, when self-monitoring to identify issues or situations for which monitoring by a teleoperations monitor arrangement may facilitate the safe operation of the vehicle.

Once the vehicle determines that monitoring is desirable, the vehicle generates a supervisory request and provides the supervisory request to a teleoperations monitor arrangement in a step 1913. In one embodiment, the vehicle may create and add a supervisory request to a queue of requests that is associated with a teleoperations monitor arrangement. It should be appreciated that providing the supervisory request to a teleoperations monitor arrangement may include transmitting the request using a wireless network such as a cellular network.

In a step 1917, the teleoperations monitor arrangement obtains and processes, e.g., assesses, the supervisory request. The teleoperations monitor arrangement may obtain and process the supervisory request based on priorities associated with requests contained in a queue of requests or a monitor queue. Processing the supervisory requests typically includes, but is not limited to including, monitoring the vehicle itself, monitoring the environment around the vehicle, and monitoring conditions encountered by the vehicle. In one embodiment, the supervisory request may specify a particular issue to monitor, and processing the supervisory request may include checking or otherwise observing the vehicle with respect to the particular issue.

A determination is made in a step 1921 as to whether the teleoperations monitor arrangement determines that the vehicle should be operated by a teleoperations system. In other words, it is determined in step 1921 if a prudent course of action is for the vehicle to be remotely controlled by a teleoperations operator arrangement.

If the determination in step 1921 is that the vehicle is not to be operated by a teleoperations system, the implication is that the vehicle may operate safely in an autonomous manner without intervention from a teleoperations system. Accordingly, in a step 1925, the teleoperations monitor arrangement logs information relating to the vehicle, and instructs the vehicle to continue to operate autonomously. Then, in a step 1929, the vehicle continues to operate autonomously, and the method of operating a teleoperations monitoring and operations platform is completed.

Alternatively, if it is determined in step 1921 that intervention by a teleoperations system is desirable, process flow proceeds to a step 1933 in which the teleoperations monitor arrangement adds the vehicle to a teleoperations operator queue which may be used to effectively assign a teleoperations operator arrangement to remotely control the vehicle. The teleoperations monitor arrangement may also notify the vehicle that the vehicle is effectively being added to a teleoperations operator queue. In one embodiment, adding the vehicle to the teleoperations operator queue includes adding contextual information associated with the vehicle to provide a teleoperations operator arrangement with situational awareness. The contextual information may include, for example, information which identifies an issue or a situation the vehicle is confronted with and an indication of why remote operation of the vehicle is requested.

From step 1933, process flow proceeds to a step 1937 in which a teleoperations operator arrangement is used to remotely operate the vehicle. Once the teleoperations operator arrangement takes control of the vehicle, the method of operating a teleoperations monitoring and operations platform is completed.

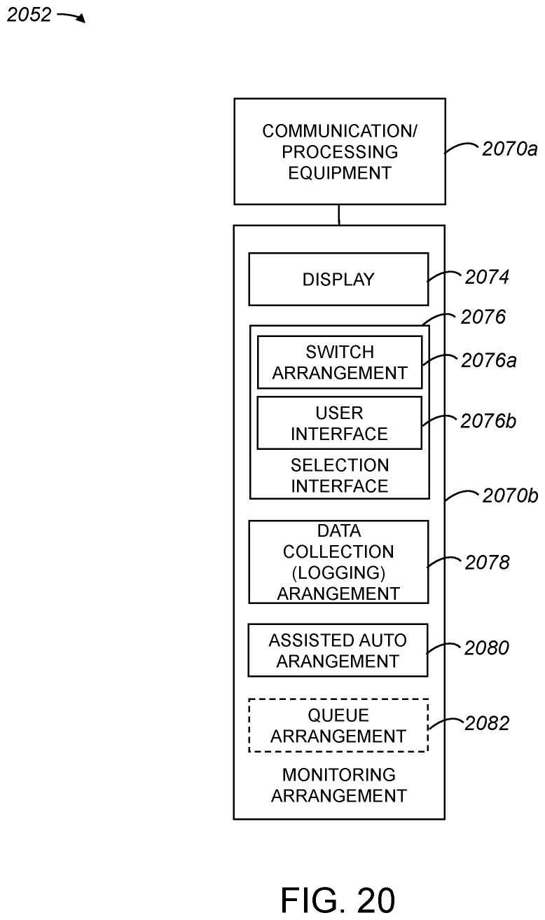

FIG. 20 is a block diagram representation of a teleoperations monitor arrangement in accordance with an embodiment. Teleoperations monitor arrangement 2052 includes communication/processing equipment 2070a and a monitoring arrangement 2070b. Communication/processing equipment 2070a may be arranged to receive or to otherwise obtain signals from a vehicle across a network, and to send or to otherwise provide signals to the vehicle across the network. Further, communication/processing equipment 2070a may also obtain signals from and/or provide signals to a teleoperations operator arrangement, e.g., teleoperations operator arrangement 1854a of FIGS. 18A and 18B.

Monitoring arrangement 2070b includes a display 2074 that may display at least one image or scene associated with a vehicle that is being monitored using teleoperations monitor arrangement 2052. That is, display 2074 may be configured to provide different views associated with a vehicle, as well as diagnostic information associated with the vehicle.

A selection interface 2076 of monitoring arrangement 2070b generally enables teleoperations monitor arrangement 2052 to select a vehicle to monitor and, in one embodiment, to select a teleoperations operator arrangement to monitor a specific vehicle. Selection interface 2076 includes a switch arrangement 2076a and a user interface 2076b. Switch arrangement 2076a may enable inputs associated with multiple vehicles, queues, and/or teleoperations operator arrangements to be provided to teleoperation monitor arrangement 2052, and user interface 2076b may enable a user such as an individual or monitor to interact with teleoperation monitor arrangement 2052 to select which vehicle. queues, and/or teleoperations operator arrangements to interact with.

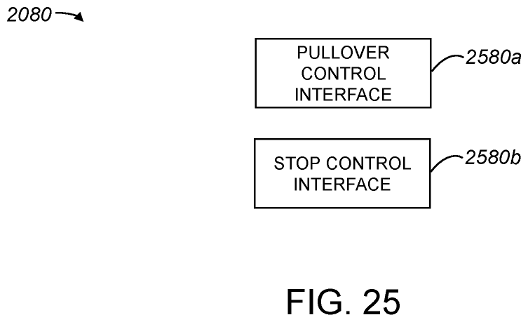

Monitoring arrangement 2070b also includes a data collection arrangement 2078, an assisted auto arrangement 2080, and an optional queue arrangement 2082. Data collection arrangement 2078 is configured to obtain and to store data associated with a vehicle that is being monitored. The data stored or logged by data collection arrangement 2078 may be provided to a teleoperations operator system when a vehicle is being added to a queue of vehicles to be controlled by a teleoperations operator arrangement. Such data may provide a context that enables an operator or controller, when controlling a vehicle using a teleoperations operator arrangement, to understand the situation faced or otherwise confronted by the vehicle. Data or information provided may include, but is not limited to including, data that indicates the potential presence of a foreign object or debris, data that indicates the presence of children, and/or data that indicates that the vehicle is in a relatively tight pull out situation. Assisted auto arrangement 2080 is configured to enable teleoperation monitor arrangement 2052 to take some actions with respect to a vehicle. For example, assisted auto arrangement 2080 may include a stop button that may be activated to cause a vehicle that is being monitored to a stop. One embodiment of assisted auto arrangement 2080 will be discussed below with respect to FIG. 25. Optional queue arrangement 2082 enables supervisory requests from vehicles to be queued for monitoring. Selection interface 2076 may be used to select a supervisory request from optional queue arrangement 2082.

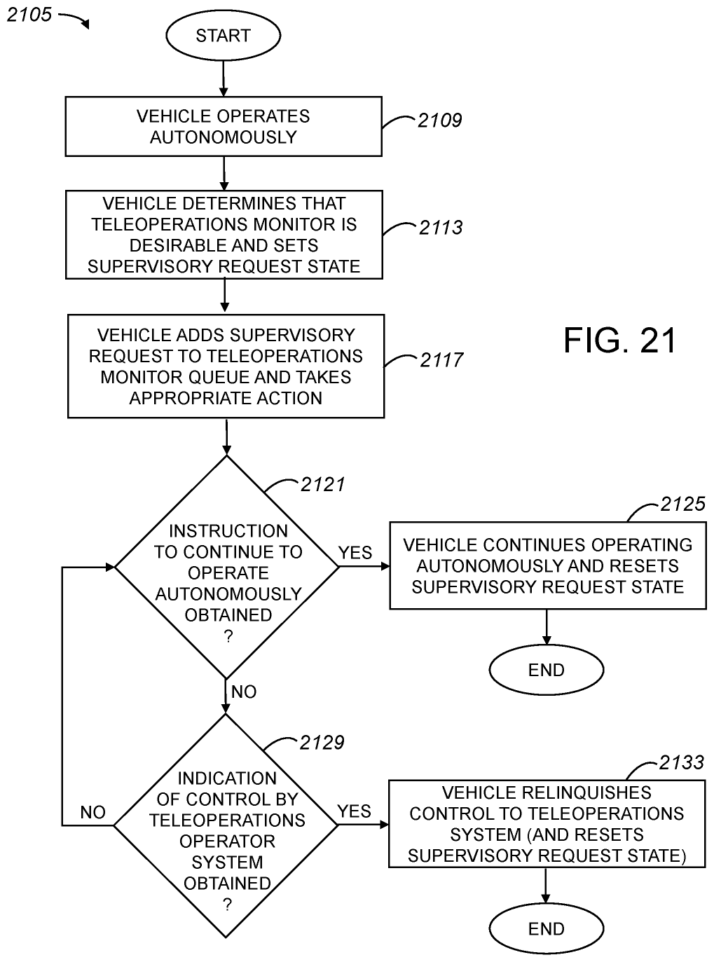

Referring next to FIG. 21, a method of operating a vehicle when the vehicle identifies a potential issue that may be mitigated by engaging a teleoperations monitor arrangement will be described in accordance with an embodiment. A method 2105 of operating a vehicle when the vehicle identifies a potential issue begins at a step 2109 when the vehicle operates autonomously. As the vehicle operates autonomously, the vehicle determine in a step 2113 that there is an issue or a situation in which monitoring by a teleoperations monitor arrangement is desirable, and sets a supervisory request state. The supervisory request state may be an indication that the vehicle sets that enables the vehicle to remain aware that the vehicle detected an issue or a situation for which monitoring is desirable.

In a step 2117, the vehicle issues a supervisory request. That is, the vehicle generates a supervisory request, and essentially adds the supervisory request to a monitor queue associated with a teleoperations monitor arrangement. Appropriate actions may include, but are not limited to including, providing information such as a video feed or diagnostic information to the teleoperations monitor arrangement. In one embodiment, the vehicle may take an appropriate action in addition to adding a supervisory request to a monitor queue. For example, the vehicle may stop or pull over until notified by the teleoperations monitor arrangement that the vehicle may continue to operate autonomously or that the vehicle is to be controlled remotely by a teleoperations operator arrangement.

It is determined in a step 2121 whether the vehicle has obtained an instruction to continue operating autonomously. That is, it is determined if the teleoperations monitor arrangement had monitored the vehicle and ascertained that the vehicle may operate autonomously. If the determination is that the vehicle may continue to operate autonomously, the vehicle continues operating autonomously in a step 2125, and resets its supervisory request state to indicate that there is no pending supervisory request. Once the vehicle continues operating autonomously, the method of operating a vehicle when the vehicle identifies a potential is issue is completed.

Alternatively, if it is determined in step 2121 that an instruction to continue to operate autonomous has not been obtained, process flow proceeds to a step 2129 in which it is determined whether an indication that the vehicle is to be controlled by a teleoperations operator system has been obtained. If it is determined that an indication of control by a teleoperations operator system has not been obtained, process flow returns to step 2121 in which it is determine whether an instruction to continue to operate autonomously has been obtained. On the other hand, if it is determined in step 2129 that an indication of control by a teleoperations operator system has been obtained, the vehicle relinquishes control to the teleoperations system and resets its supervisory request state in a step 2133, and the method of operating a vehicle when the vehicle identifies a potential is issue is completed.

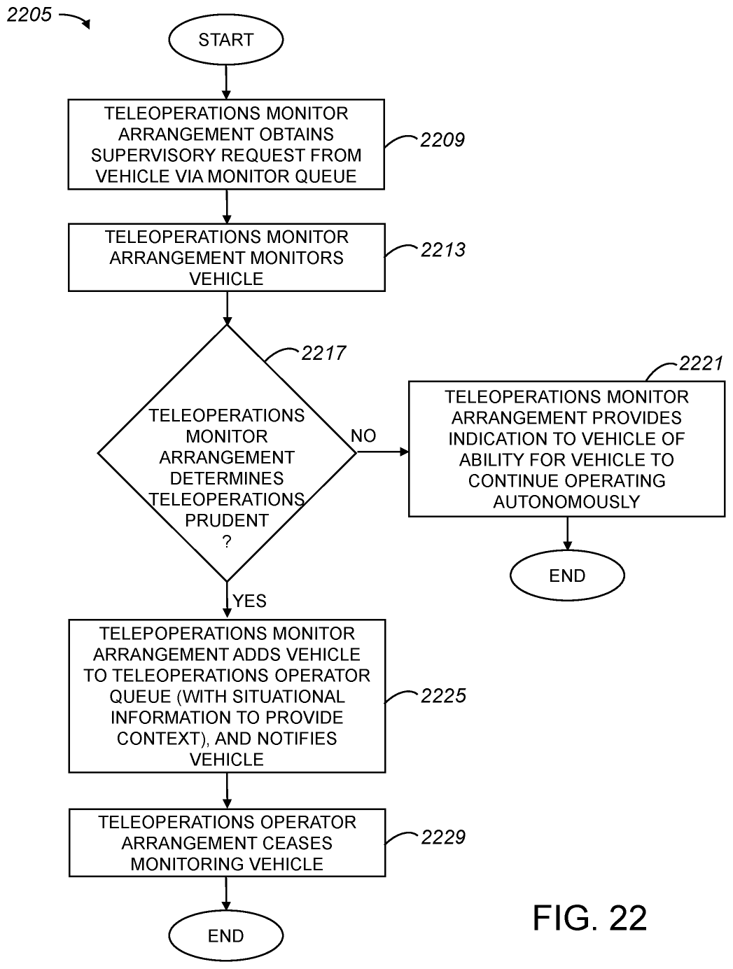

FIG. 22 is a process flow diagram which illustrates a method of operating a teleoperations monitor arrangement in accordance with an embodiment. A method 2205 of operating a teleoperations monitor arrangement begins at a step 2209 in which a teleoperations monitor arrangement obtains a supervisory request from a vehicle that determines, as for example through self-monitoring, that teleoperations monitoring is desirable. The vehicle may determine that there is an issue or a potential issue which may be substantially mitigated by a teleoperations monitor arrangement, and may add a supervisory request to a monitor queue associated with the teleoperations monitor arrangement. In general, the teleoperations monitor arrangement may obtain the oldest supervisory request in the queue or the most critical supervisory request in the queue.

In a step 2213, the teleoperations monitor arrangement monitors the vehicle. Monitoring the vehicle may include, but is not limited to including, obtaining data such as visual and audial information from the vehicle, obtaining diagnostic information from the vehicle, and rendering or otherwise displaying information on a screen of the teleoperations monitor arrangement such that the information may be consumed. The teleoperations monitor arrangement may monitor the vehicle by processing data transmitted by the vehicle to ascertain whether the vehicle may benefit from being teleoperated.

A determination is made in a step 2217 as to whether the teleoperations monitor arrangement determines that teleoperations for the vehicle are prudent. That is, the teleoperations monitor arrangement may process information associated with the vehicle to determine whether the vehicle may operate safely in an autonomous manner, or whether the vehicle is to be operated autonomously.

If the determination in step 2217 is that teleoperating the vehicle is effectively unnecessary, the indication is that the vehicle may safely operate autonomously. Accordingly, in a step 2221, the teleoperations monitor arrangement provides an indication to the vehicle that is arranged to inform the vehicle that the vehicle may operate autonomously. In one embodiment, when the vehicle is stopped or pulled over awaiting a response to a supervisory request, the vehicle may be informed that the vehicle may once again begin operating autonomously. It should be appreciated that in some instances, the teleoperations monitor arrangement may issue a command to the vehicle or take an action with respect to the vehicle in conjunction with informing the vehicle that the vehicle may operate autonomously. After the teleoperations monitor arrangement provides an indication to the vehicle, the method of operating a teleoperations monitor arrangement is completed.

Returning to step 2217 and the determination of whether the vehicle is to be remotely controlled by a teleoperations operator arrangement, when it is determined that the vehicle is to be remotely controlled by the teleoperations arrangement, process flow moves to a step 2225 in which the teleoperations monitor arrangement effectively adds the vehicle to a teleoperations operation queue and notifies the vehicle that a teleoperations operation arrangement will remotely control the vehicle. When the teleoperations monitor arrangement adds the vehicle to the teleoperations operation queue, the teleoperations monitor arrangement may provide situational information that provides a context associated with the vehicle. The situational information may include, but is not limited to including, a description of the situation that the vehicle is facing, video or audio which provides an indication of the situation the vehicle is in, and/or data which indicates the current state of the vehicle. In one embodiment, situational information may include labels, e.g., labels created by an individual using a teleoperations monitor arrangement, which identify the situation.

Once the teleoperations monitor arrangement adds the vehicle to the teleoperations operator queue and notifies the vehicle, the teleoperations operator arrangement may ease monitoring the vehicle in a step 2229. The method of operating a teleoperations monitor arrangement is completed upon the teleoperations monitor arrangement ceasing to monitor the vehicle.

As mentioned above, supervisory requests that are queued for processing may be processed based on a first-in-first-out order. In one embodiment, supervisory requests may instead be processed primarily in an order based on a criticality or a level of importance. For example, the most critical supervisory request may be processed first, and the least critical supervisory request may be processed substantially last. The critical level of a situation may be based on any suitable criteria including, but not limited to including, the environment around the vehicle, the type of mission the vehicle is engaged in, and/or the issue the vehicle is faced with.

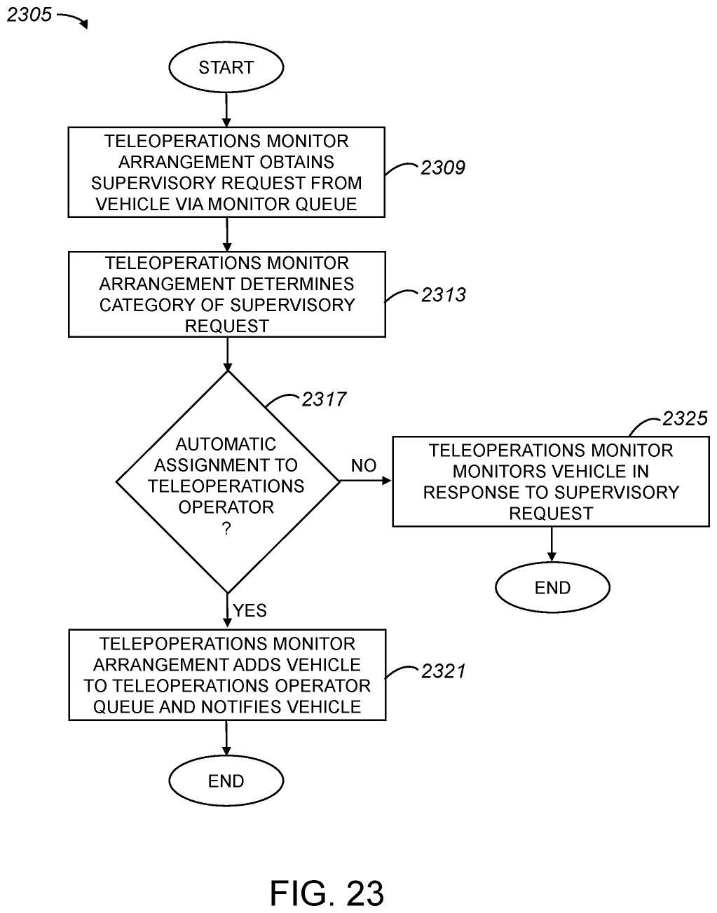

FIG. 23 is a process flow diagram which illustrates a method of using a teleoperations monitor arrangement in an overall system in which supervisory requests are associated with critical levels in accordance with an embodiment. A method 2305 of using a teleoperations monitor arrangement in an overall system in which supervisory requests are substantially categorized or leveled begins at a step 2309 in which a teleoperations monitor arrangement, or more specifically, a monitor queue associated with the teleoperations monitor arrangement, obtains a supervisory request from a vehicle. The supervisory request may be initiated by the vehicle in response to an issue or a potential issue that the vehicle has detected through self-monitoring.

In a step 2313, the teleoperations monitor arrangement determines the category or level of the supervisory request. Generally, specific types of supervisory request may be defined and associated with categories or levels and, as such, determining the category or the level of the supervisory request obtained in step 2309 may involve mapping the supervisory request to a predetermined category or level.

A determination is made in a step 2317 as to whether the category or level of the supervisory request indicates that a teleoperations operator is substantially automatically assigned to teleoperate, or to otherwise remotely control the vehicle. It should be appreciated that for some categories or levels of supervisory requests, a substantially automatic assignment to a teleoperations operator may occur.

If it is determined in step 2317 that an automatic assignment of control of the vehicle is to be assigned to a teleoperations arrangement, the teleoperations monitor effectively adds the vehicle to a teleoperations operator queue, and notifies the vehicle that the vehicle is to be remotely operated in a step 2321. Once the vehicle is added to the teleoperations operator queue and the vehicle is appropriately notified, the method of using a teleoperations monitor arrangement in an overall system in which supervisory requests are substantially leveled is completed.

Alternatively, if it is determined in step 2317 that the supervisory request is not to be automatically assigned to a teleoperations operator, process flow proceeds to a step 2325 in which the teleoperations monitor monitors the vehicle in response to the supervisory request of the vehicle. The method of using a teleoperations monitor arrangement in an overall system in which supervisory requests are substantially leveled is completed upon the teleoperations monitor monitoring the vehicle.

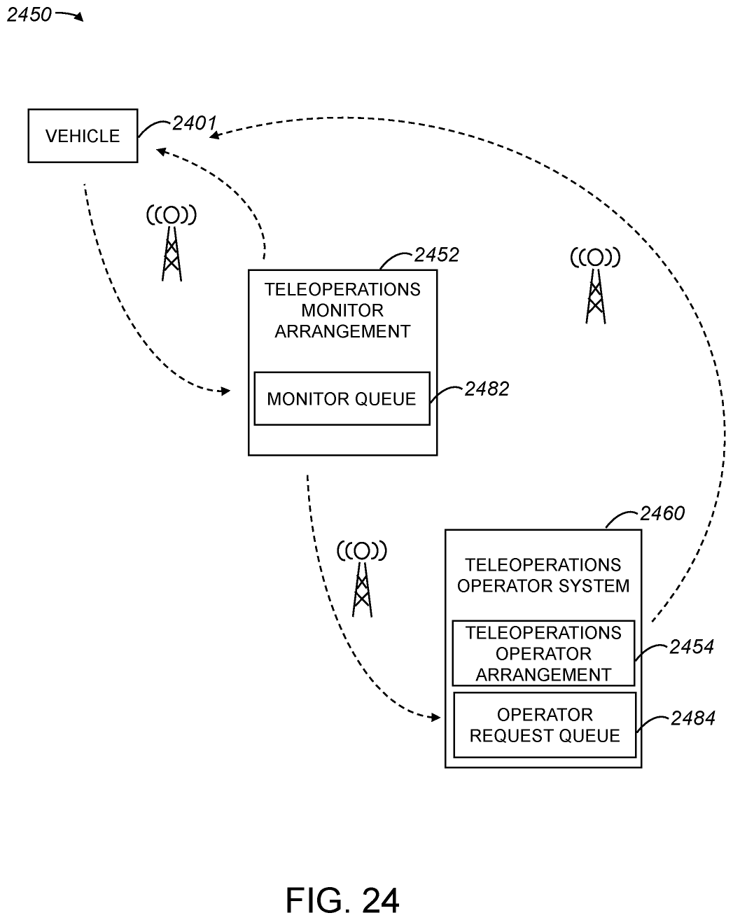

With reference to FIG. 24, communications associated with a teleoperations monitoring and operations platform which includes a self-monitoring vehicle will be described in accordance with an embodiment. A teleoperations monitoring and operations platform 2450 includes a self-monitoring autonomous vehicle 2401, a teleoperations monitor arrangement 2452, and a teleoperations operator system 2460.

Vehicle 2401 is configured to determine when supervision or monitoring by teleoperations monitor arrangement 2452 is to be requested, as for example by sending a supervisory request to teleoperations monitor arrangement 2452 through a network. Teleoperations monitor arrangement 2452 may monitor vehicle 2401, and determine whether vehicle 2401 may safely operate autonomously or may benefit from remote control by teleoperations operation system 2460. When teleoperations monitor arrangement 2452 determines that vehicle 2401 may benefit from remote control, teleoperations monitor arrangement 2452 may communicate with teleoperations operator system 2460.

Teleoperations monitor arrangement 2452 includes, in one embodiment, a monitor queue 2452 configured to queue supervisory requests obtained by teleoperations monitor arrangement 2482 from vehicles such as vehicle 2401. Teleoperations monitor arrangement 2452 may process supervisory requests, as for example by monitoring a vehicle that initiated a supervisory request, in any suitable order. A suitable order for processing supervisory requests may include, but are not limited to including, a first-in-first-out order and/or an order based on priority or severity levels of queued supervisory requests. It should be appreciated that if monitor queue 2482 is substantially empty when a supervisory request is obtained from vehicle 2401, that supervisory request may be processed substantially immediately, or effectively without being queued.

Teleoperations operator system 2460 includes at least one teleoperations operator arrangement 2454 that is arranged to be used by an operator or a controller to remotely control vehicle 2401, e.g., on an as needed basis. In one embodiment, teleoperations operator system 2460 includes an operator request queue 2484 which is configured to queue requests for control of a vehicle such as vehicle 2401 by teleoperations operator arrangement 2454. Requests for control may generally be processed or otherwise assigned to teleoperations operator arrangement 2454 from operator request queue 2484 in any suitable order including, but not limited to including, a first-in-first-out order and/or an order based on the priority or severity levels associated with the situation vehicles such as vehicle 2401 are in or otherwise facing.

As previously mentioned, an assisted auto arrangement may be included in a teleoperations monitor arrangement to enable a teleoperations monitor to send some instructions to an autonomous vehicle. That is, while a teleoperations monitor arrangement generally may not control an autonomous vehicle through teleoperations, the teleoperations monitor arrangement may include functionality that enables the teleoperations monitor arrangement to provide some instructions to be followed by the autonomous vehicle. FIG. 25 is a block diagram representation of an assisted auto arrangement, e.g., assisted auto arrangement 2080 of FIG. 20, in accordance with an embodiment. Assisted auto arrangement 2080, which is typically part of a teleoperations monitor arrangement, is configured to provide substantially emergency assistance to an autonomous vehicle which has, in one embodiment, requested supervision from the teleoperations monitor arrangement. Assisted auto arrangement 2080 may be embodied as part of a computing system, e.g., on a laptop or tablet computer.

Assisted auto arrangement 2080 may include a pullover control interface 2580a and a stop control interface 2580b. Pullover control interface 2580a includes hardware and/or software logic which enables a signal or instruction to be provided to an autonomous vehicle which causes the autonomous vehicle to effectively pullover, e.g., on a side of a road. Stop control interface 2580b includes hardware and/or software which enables a signal or instruction to be provided to an autonomous vehicle which causes the autonomous vehicle to come to a stop, as for example substantially as soon as stopping is determined by the autonomous vehicle to be relatively safe. Pullover control interface 2580a and stop control interface 2580b may be implemented, in one embodiment, as buttons on a display screen of a teleoperations monitor arrangement that may be activated or otherwise selected to cause a pullover or stop action to be executed by an autonomous vehicle.

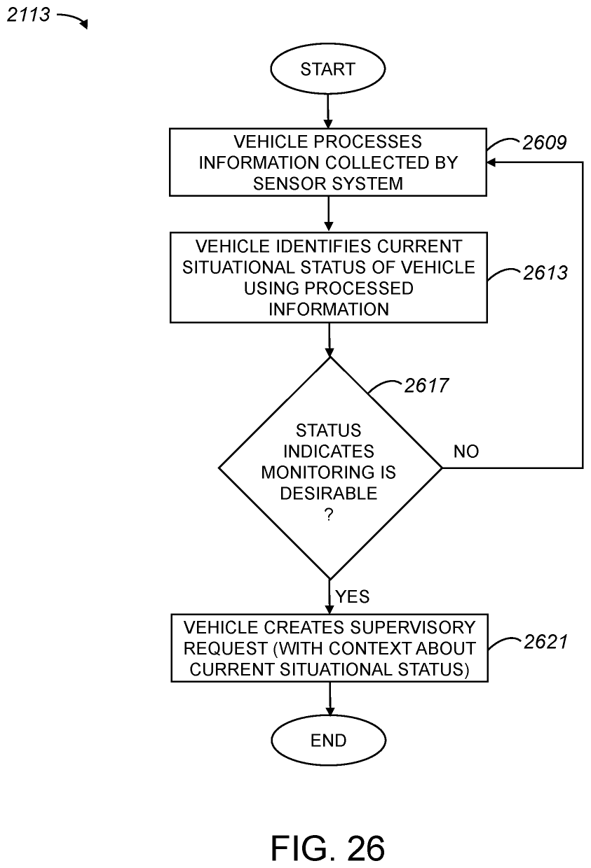

An autonomous vehicle may perform self-monitoring to determine whether to request monitoring from a teleoperations monitor, and identify situations for which the autonomous vehicle may send a request for monitoring, e.g., external monitoring from a teleoperations monitor. Referring next to FIG. 26, one method of determining whether a teleoperations monitor is to be requested, e.g., step 2113 of FIG. 21, will be described in accordance with an embodiment. A method 2113 of determining whether a teleoperations monitor is to be requested by a vehicle begins at a step 2609 in which the vehicle processes information collected by a sensor system of vehicle, as for example sensor system 324 of FIG. 3 and sensor system 324′ of FIG. 17. The information may include, but is not limited to including, information associated with the state of the vehicle, information associated with the surroundings around the vehicle, and/or information associated with environmental conditions such as temperature and precipitation in which the vehicle is operating.

Information associated with the state of the vehicle may include, but is not limited to including, information which identifies whether the vehicle has been involved in a collision, information which indicates a current amount of electric charge or a fuel level of the vehicle, and/or information associated with systems on the vehicle. Information associated with the surroundings around the vehicle may include, but is not limited to including, information which identifies obstacles in the path of the vehicle and objects which the vehicle is unable to identify.

After the vehicle processes the information, the vehicle identifies a current situational status of the vehicle using the processed information in a step 2613. The current situational status may specify an issue that the vehicle is facing or currently confronted with. It should be appreciated that the current situational status may indicate that the vehicle is operating as expected and that there are no issues for which monitoring is desirable.

A determination is made in a step 2617 as to whether the current situational status indicates that monitoring is desirable. If the determination is that the current situational status indicates that monitoring is not desirable, the indication is that the vehicle is not faced with relatively imminent issues for which monitoring may be desired. Accordingly, process flow returns to step 2609 in which the vehicle processes information collected by the sensor system.

Alternatively, if the determination in step 2617 is that the current situational status indicates that monitoring is desirable, then in a step 2621, the vehicle creates a supervisory request, The supervisory request may include contextual information which relates to the current situation status. Providing contextual information enables a teleoperations monitor to understand the issue for which supervisory monitoring is requested. Once the vehicle creates the supervisory request, the method of determining whether a teleoperations monitor is to be requested is completed.

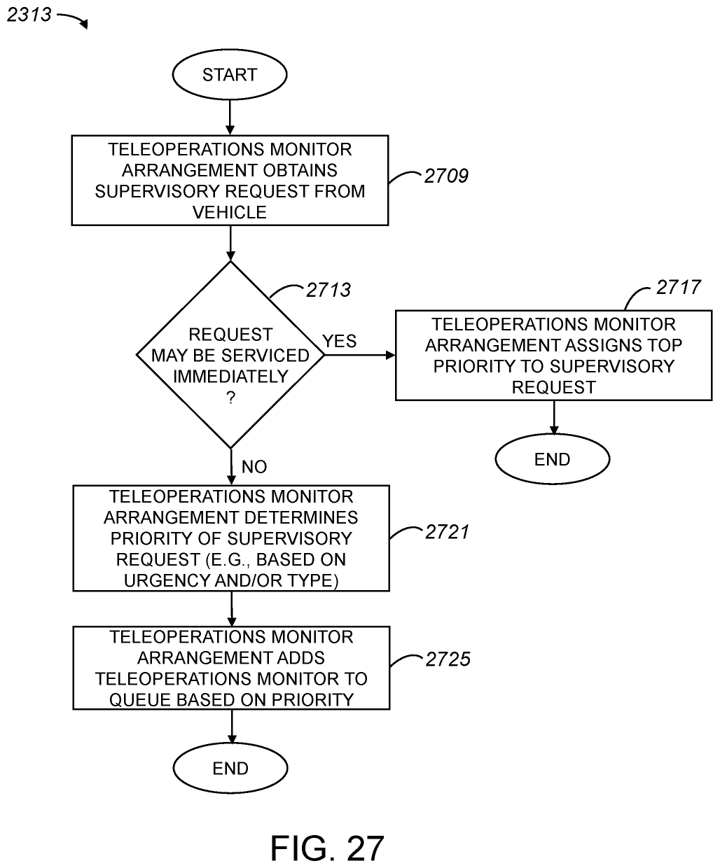

FIG. 27 is a process flow diagram which illustrates a method of determining a category for a supervisory request obtained from an autonomous vehicle whether a teleoperations monitor is to be requested, e.g., step 2213 of FIG. 23, in accordance with an embodiment. A method 2131 of determining a category for a supervisory request begins at a step 2709 in which a teleoperations monitor arrangement obtains a supervisory request from a vehicle. Once the supervisory request is obtained, a determination is made in a step 2713 as to whether the received request may be serviced substantially immediately. In other words, it is determined whether the request is to be queued.

If the determination in step 2713 is that the request may be serviced substantially immediately, then process flow proceeds to a step 2717 in which the teleoperations monitor arrangement assigns a top priority to the supervisory request. The method of determining a category for a supervisory request is completed upon the top priority being assigned to the supervisory request.

Alternatively, if the determination is that the request may not be services substantially immediate, the implication is that there is at least one other request that the teleoperations monitor arrangement is expected to service. Accordingly, process flow moves to a step 2721 in which the teleoperations monitor arrangement determines a priority for the supervisory request.

Determining the priority of the supervisory request may include, but is not limited to including, whether one or more potential issues identified in the supervisory request may be critical to the safe operation of a vehicle, whether the vehicle may continue to operate safely in view of the potential issues and/or whether the vehicle is in an inoperable condition. By way of example, when the issue is a detected collision involving the vehicle, such an issue may have a highest priority. When the potential issue may essentially be mitigated by the vehicle operating in a failover mode, the issue may have a lower priority. The priorities may also be determined based on an issued type. For instance, physical vehicle issues relating to hardware and/or software may be assigned a higher priority than issues associated with environmental conditions. In some embodiments, when the supervisory request is the newest request obtained by the teleoperations monitor arrangement, the supervisory request may be assigned a relatively low priority. It should be appreciated that priorities may vary, and may generally be set by an enterprise that manages the vehicle.

After the priority of the supervisory request is substantially assigned, the teleoperations monitor arrangement adds the supervisory request to a monitor queue based on the priority in a step 2725. The method of determining a category for a supervisory request is completed once the supervisory request is queued for service.

A teleoperations monitor arrangement associated with a self-monitoring autonomous vehicle may be configured to provide substantially automatic monitoring of the autonomous vehicle in some situations and locations. That is, a teleoperations monitor arrangement may effectively watch a self-monitoring autonomous vehicle in some situations. The teleoperations monitor arrangement may determine, based on information provided by an autonomy system, a context map, and/or sensors of an autonomous vehicle, when the autonomous vehicle is in a situation or a location at which substantially automatically monitoring of the autonomous vehicle is to be performed by the teleoperations monitor arrangement. Such information may be provided as a supervisory request from the autonomous vehicle, although it should be appreciated that such information is not limited to being provided as a supervisory request. In one embodiment, a teleoperations monitor arrangement may use a geo fence associated with an autonomy system of an autonomous vehicle, e.g., a geo fence added to a context map, to determine when to monitor the area or zone within the geo fence. In such an embodiment, the autonomy system may issue a supervisory request when the autonomous vehicle enters a geo fenced area. When a zone is designated on a context map as an area within which a teleoperations monitor arrangement is to be used to monitor an autonomous vehicle, the teleoperations monitor arrangement may be substantially automatically triggered to monitor the autonomous vehicle when the autonomous vehicle is present within the zone.

In one embodiment, when a self-monitoring vehicle arrives at an intended destination such as a delivery location, a teleoperations monitor arrangement may be used to substantially automatically monitor the self-monitoring vehicle. By monitoring the self-monitoring vehicle at a delivery location, issues which may arise when handing off a delivery to a recipient may be more readily mitigated when the hand off is observed using a teleoperations monitor arrangement. In another embodiment, when a self-monitoring vehicle drives through a particular zone such as a school zone, a teleoperations monitor arrangement may be used to substantially monitor the vehicle to effectively ensure that the self-monitoring vehicle is compliant with the rules established for school zones.

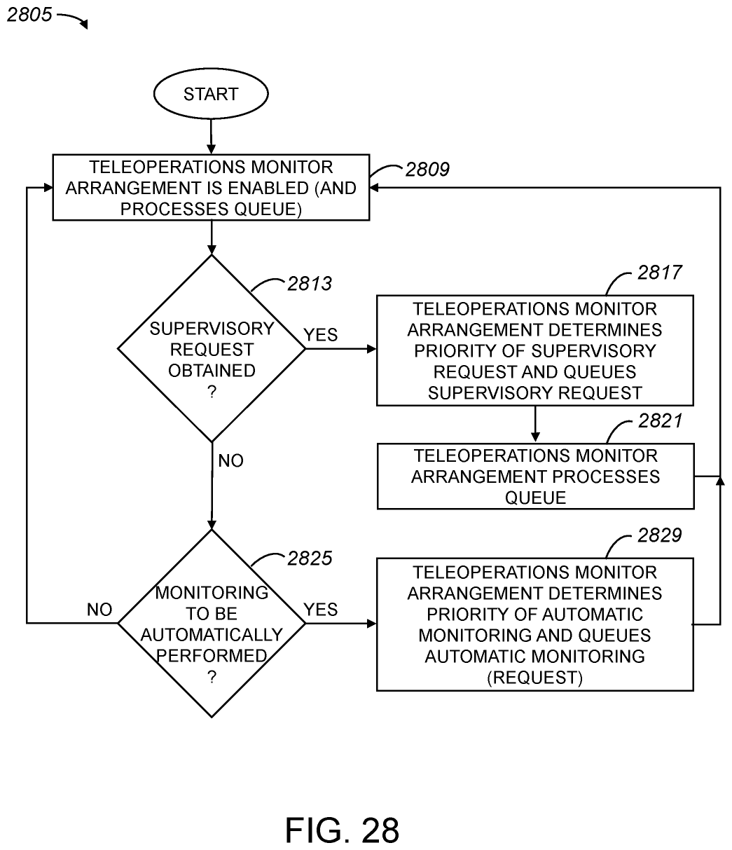

FIG. 28 is a process flow diagram which illustrates a method of processing supervisory requests and substantially automatic monitoring requests relating to an autonomous vehicle in accordance with an embodiment. A method of processing requests 2805 begins at a step 2809 in which a teleoperations monitor arrangement is enabled or otherwise online. That is, the teleoperations monitor arrangement is effectively on-call and ready to be used, by a teleoperations monitor, to monitor an autonomous vehicle. The teleoperations monitor arrangement may generally be processing queued requests as it effectively awaits new requests.

In a step 2813, a determination is made as to whether a supervisory request has been obtained from an autonomous vehicle. If the determination is that a supervisory request has been obtained, then in a step 2817, the teleoperations monitor arrangement determines a priority of the supervisory request, and queues the supervisory request. The supervisory requests is queued based on the determined priority. Then, in a step 2821, the teleoperations monitor arrangement causes requests in the queue to be processed. Process flow returns from step 2821 to step 2809 in which the teleoperations monitor arrangement effectively awaits further requests.

Alternatively, if it is determined in step 2813 that a supervisory request has not been obtained, then in a step 2825, it is determined whether monitoring is to be substantially automatically performed. In other words, it is determined whether an autonomous vehicle is in a situation, or at a location, at which the autonomous vehicle is generally monitored by a teleoperations monitor arrangement. By way of example, the autonomous vehicle may be located at a drop off point for a delivery, or the autonomous vehicle may be in a school zone.

The determination of whether monitoring is to be substantially automatically performed may be based upon information that the teleoperations monitor arrangement obtains from systems on an autonomous vehicle. For example, a sensor system and an autonomy system may provide information to the teleoperations monitor system which indicates to the teleoperations monitor system that monitoring is to be substantially automatically performed. However, it should be understood that in some situations, information or data which identifies a condition for which monitoring is to be substantially automatically performed may be provided in a supervisory request. That is, an indication that the teleoperations monitor arrangement is to monitor the vehicle due to a location of the vehicle may be provided in a supervisory request.

If it is determined in step 2825 that monitoring is not to be automatically performed, process flow returns to step 2809 in which the teleoperations monitor arrangement continues to effectively remain on call and to process queued requests. Alternatively, if it is determined that monitoring is to be automatically performed, then in a step 2829, the teleoperations monitor arrangement determines a priority for performing automatic monitoring, and queues the automatic monitoring based on the priority. Once the priority for the automatic monitoring is determined and the automatic monitoring is queued, process flow returns to step 2809 in which the teleoperations monitor arrangement continues to effectively remain on call and to process queued requests.

In some situations, a teleoperations monitor using a teleoperations monitor arrangement may elect to monitor a particular self-monitoring vehicle. Such a teleoperations monitor may effectively be a teleoperations administrator or supervisor, and such a teleoperations monitor arrangement may effectively be a teleoperations administrator arrangement. For instance, a teleoperations administrator may use a teleoperations administration arrangement to effectively triage requests for control that are queued for handing by a teleoperations operator, and effectively determine that the order of requests in the queue are to be overridden. In some instances, a self-monitoring vehicle may record information such as video information that may be stored such that a teleoperations administrator arrangement may playback the recorded information, as for example when a teleoperations administrator determines that it may be advisable to effectively review any issues faced by the self-monitoring vehicle at an earlier time. That is, a teleoperations administrator arrangement may obtain video recorded by a vehicle for playback purposes. It should be appreciated that a teleoperations administrator arrangement may include capabilities associated with a teleoperations monitor arrangement, as well as additional capabilities such as video playback capabilities and other capabilities which enable a queue of vehicles requesting monitoring and/or a queue of vehicles to be controlled remotely by a teleoperator to be reordered.

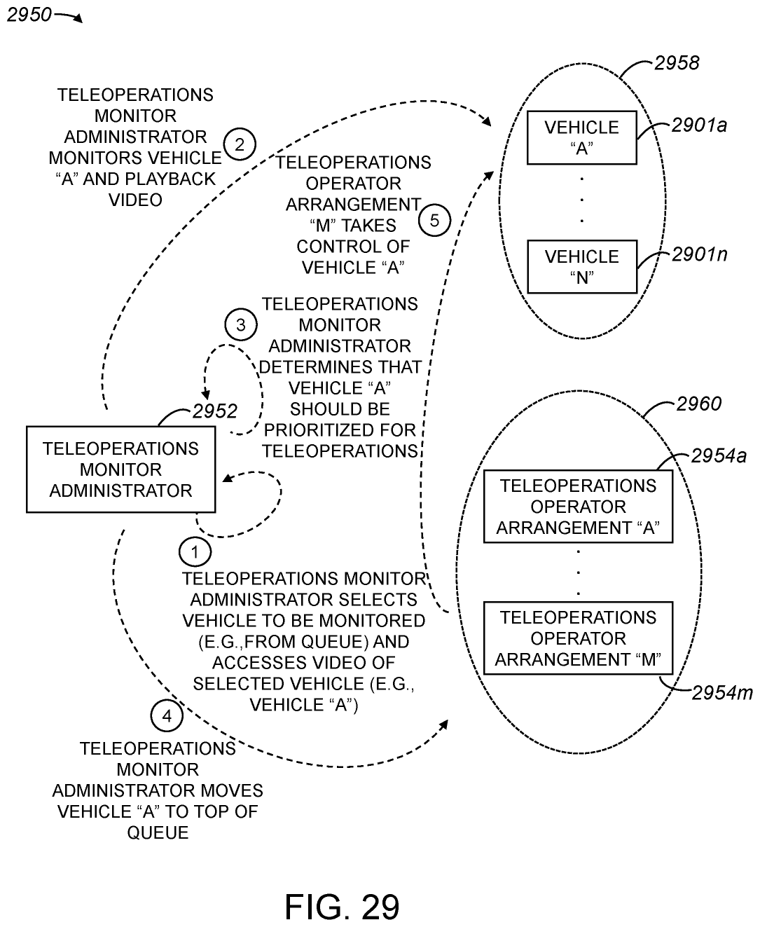

FIG. 29 is a diagrammatic representation of a teleoperations monitoring and operations platform which includes teleoperations monitor administrator configured to select a particular self-monitoring vehicle to be expedited for control by a teleoperations operator arrangement in accordance with an embodiment. A platform 2950 includes a teleoperations monitor administrator 2952, a fleet 2958 of vehicles 2901a-n, and a pool 2960 of teleoperations operator arrangements 2954a-m. Teleoperations monitor administrator 2952 has the capability to monitor vehicles 2901a-n, and to identify when a vehicle 2901a-n may benefit from being controlled by one of teleoperations operator arrangement 2954a-m.

In the described embodiment, a queue (not shown) may be accessible to teleoperations monitor administrator 2952. The queue may effectively identify vehicle “A” 2901a, for example, as either requesting monitoring or awaiting an assignment of a teleoperations operator arrangement 2954a-m. That is, the queue may either be a queue that includes vehicles 2901a-n awaiting monitoring or a queue that includes vehicles 2901a-n awaiting assignment to a teleoperations operator arrangement 2954a-m. In general, teleoperations monitor administrator 2952 has the capability to select a particular vehicle 2901a-n to monitor, and to view a playback of recent video or images associated with the particular vehicle 2901a-n, regardless of whether the particular vehicle 2901a-n in in a queue.

At a time t1, teleoperations monitor administrator 2952 selects vehicle “A” 2901a to be monitored, and access a video, e.g., a video that was recently recorded by vehicle “A” 2901a. It should be appreciated that teleoperations monitor administrator 2952 may select vehicle “A” 2901a for any suitable reason. For example, vehicle “A” 2901a may be selected if vehicle “A” 2901a has previously had an issue, if vehicle “A” 2901 is in a location that has previously been associated with issues, and/or if teleoperations monitor administrator 2952 is effectively randomly selecting vehicles 2901a-m to monitor.

At a time t2, teleoperations monitor administrator may monitor vehicle “A” 2901a and playback video previously recorded by vehicle “A” 2901a. In one embodiment, teleoperations monitor administrator 2952 may used by a substantially supervisory teleoperations monitor to essentially determine whether vehicle “A” 2901a should be prioritized for operation by a teleoperations operator arrangement 2954a-m.

Teleoperations monitor administrator 2952 determines at a time t3 that vehicle “A” 2901a is to be prioritized for teleoperations. As such, at a time t4, teleoperations monitor administrator 2952 moves vehicle “A” 2901a substantially to a top of a queue of vehicles 2901a-n awaiting control by a teleoperations operator arrangement 2954a-m. At a time t5, teleoperations operator arrangement “A” 2954a takes control of vehicle “A” 2901a.

Although only a few embodiments have been described in this disclosure, it should be understood that the disclosure may be embodied in many other specific forms without departing from the spirit or the scope of the present disclosure. By way of example, when a teleoperations monitor arrangement determines that a teleoperations operator arrangement is to take control of a vehicle, the teleoperations monitor arrangement may effectively allow the vehicle to continue to operate autonomously until the teleoperations operator arrangement is able to take control of the vehicle. In lieu of allowing the vehicle to continue to operate autonomously, the teleoperations monitor arrangement may instead provide a notification, e.g., to the vehicle or to a fleet manager which may communicate with the vehicle, which indicates that the vehicle is to pull over an await control by the teleoperation operator arrangement.

The number of teleoperations monitor arrangements associated with a platform may vary widely. The number of teleoperations monitor arrangements may depend, at least in part, upon the number of vehicles each teleoperations monitor arrangement may monitor substantially simultaneously.

A teleoperations monitor arrangement may generally visually monitor one or more vehicles substantially simultaneously. That is, a teleoperations monitor arrangement may generally obtain images from vehicles, e.g., video images from one or more cameras on the vehicles, and display those images on display screens of the teleoperations monitor arrangement. It should be understood, however, that monitoring is not limited to visual monitoring. For instance, monitoring may include, but is not limited to including, obtaining data pertaining to systems of each monitored vehicle and providing such data in a format that may be reviewed by a monitor using the teleoperations monitoring arrangement. For example, data may be obtained from sensors on a vehicle that relates to the status of different systems, and such data may be monitored to determine when there may be an issue.

While a teleoperations monitor arrangement has been described as including a single display, a teleoperations monitor arrangement is not limited to including a single display. In other words, a teleoperations monitor arrangement may include multiple displays that may be used to monitor multiple vehicles substantially simultaneously.

A teleoperations monitor arrangement has generally been described as determining, in response to a supervisory request received from a vehicle, whether the vehicle is to be remotely operated by a teleoperations operator arrangement. When it is determined that the vehicle is to be remotely operated, the teleoperations monitor arrangement may effectively provide a request, in addition to situational information that provides context relating to the situation the vehicle is in, to a teleoperations operator arrangement. It should be understood, however, that in lieu of a teleoperations monitor arrangement effectively engaging a teleoperations operator arrangement on behalf of a vehicle, the teleoperations monitor arrangement may instead instruct the vehicle to engage a teleoperations operator arrangement.

When a vehicle determines that a supervisory request is to be provided to a teleoperations monitor arrangement, the vehicle may stop or pull over to await either an indication that the vehicle may once again operate autonomously is provided or an indication that the vehicle is to be remotely controlled by a teleoperations operator arrangement, as discussed above. In one embodiment, in lieu of stopping or pulling over, a vehicle may continue to operate autonomously while awaiting a response to an issued supervisory request. That is, in some situations, a vehicle may continue to operate safely until a supervisory request is addressed. For instance, a supervisory request may be issued by a vehicle that is at the end of a delivery mission to enable a teleoperations monitor arrangement to identify whether recipients of a delivery are a safe distance away from the approaching vehicle. In such a situation, the vehicle may continue to operate autonomously while the teleoperation monitor arrangement monitors the vehicle.

When a teleoperations monitor arrangement determines that a teleoperations operator arrangement is to take control of a vehicle while the vehicle which issued a supervisory request is allowed to continue to operate while awaiting a response to the supervisory request, the teleoperations monitor arrangement may effectively allow the vehicle to continue to operate autonomously until a teleoperations operator arrangement is able to take control of the vehicle. Rather than allow the vehicle to continue to operate autonomously, the teleoperations monitor arrangement may instead provide a notification, e.g., to the vehicle or to a fleet manager which may communicate with the vehicle, which indicates that the vehicle is to pull over to await control by the teleoperation operator arrangement, without departing from the spirit or the scope of the disclosure.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining, at a monitoring arrangement, a first supervisory request from a first vehicle, the first supervisory request arranged to indicate that the first vehicle has identified a first potential issue;
processing, at the monitoring arrangement, the first supervisory request, wherein processing the first supervisory request includes determining whether the first potential issue is to be mitigated; and
when it is determined that the first potential issue is to be mitigated, providing information from the monitoring arrangement to a control arrangement, wherein the control arrangement takes control of the first vehicle based on the information.

2. The method of claim 1 wherein the first vehicle is a vehicle capable of operating autonomously and the control arrangement is a teleoperations arrangement, and wherein the first vehicle is operating autonomously when the first supervisory request is obtained at the monitoring arrangement.

3. The method of claim 2 wherein when it is determined that the first potential issue is not to be mitigated, the monitoring arrangement provides an instruction to the first vehicle, the instruction being arranged to indicate that the first vehicle is to continue to operate autonomously.

4. The method of claim 2 wherein determining whether the first potential issue is to be mitigated includes determining whether the first potential issue is to be addressed by using the teleoperations arrangement to control the first vehicle.

5. The method of claim 1 wherein processing the first supervisory request includes determining a priority for the first supervisory request, and adding the first supervisory request to a queue of supervisory requests that are to be serviced, wherein the first supervisory request is added to the queue based on the priority.

6. The method of claim 5 wherein the queue of supervisory requests includes at least a second supervisory request, the second supervisory request being obtained at the monitoring arrangement from a second vehicle, the second supervisory request being a request to monitor the second vehicle using the monitoring arrangement.

7. The method of claim 5 wherein identifying the priority associated with the first supervisory request includes determining whether the first vehicle may operate safely in view of the first potential issue.

8. Logic encoded in one or more tangible non-transitory, computer-readable media for execution and when executed operable to:
obtain a first supervisory request from a first vehicle, the first supervisory request arranged to indicate that the first vehicle has identified a first potential issue;
process the first supervisory request, wherein the logic operable to process the first supervisory request includes logic operable to determine whether the first potential issue is to be mitigated; and
provide information to a control arrangement when it is determined that the first potential issue is to be mitigated, wherein the control arrangement takes control of the first vehicle based on the information, the control arrangement being separate from the first vehicle.

9. The logic of claim 8 wherein the first vehicle is a vehicle capable of operating autonomously and the control arrangement is a teleoperations arrangement, and wherein the first vehicle is operating autonomously when the first supervisory request is obtained.

10. The logic of claim 9 wherein the logic is further operable to provide an instruction to the first vehicle wherein when it is determined that the first potential issue is not to be mitigated, the instruction being arranged to indicate that the first vehicle is to continue to operate autonomously.

11. The method of claim 9 wherein determining whether the first potential issue is to be mitigated includes determining whether the first potential issue is to be addressed by using the teleoperations arrangement to control the first vehicle.

12. The logic of claim 8 wherein the logic operable to process the first supervisory request is operable to determine a priority for the first supervisory request, and the logic operable to add the first supervisory request to a queue of supervisory requests that are to be serviced is operable to add the first supervisory request to the queue based on the priority.

13. The logic of claim 12 wherein the queue of supervisory requests includes at least a second supervisory request, the second supervisory request being obtained from a second vehicle, the second supervisory request being a request to monitor the second vehicle using the monitoring arrangement.

14. The logic of claim 12 wherein the logic operable to identify the priority associated with the first supervisory request includes logic operable to determine whether the first vehicle may operate safely in view of the first potential issue.

15. A system comprising:
a plurality of vehicles, the plurality of vehicles configured to operate autonomously, wherein the plurality of vehicles includes a first vehicle;
a monitoring arrangement, the monitoring arrangement configured to monitor the plurality of vehicles, the monitoring arrangement including at least one display screen arranged to display information provided by the plurality of vehicles, the monitoring arrangement arranged to obtain a first supervisory request from the first vehicle, the monitoring arrangement further being arranged to service the first supervisory request to determine whether the first vehicle is to be controlled remotely; and
a control arrangement, the control arrangement being configured to control the plurality of vehicles remotely, wherein the control arrangement takes control of the first vehicle when the monitoring arrangement determines that the first vehicle is to be controlled remotely.

16. The system of claim 15 wherein the monitoring arrangement includes a queue of supervisory requests, and wherein the monitoring arrangement is configured to determine a priority for the first supervisory request and to add the first supervisory request to the queue based on the priority before servicing the first supervisory request.

17. The system of claim 15 wherein when the monitoring arrangement determines that the first vehicle is to be controlled remotely, the monitoring arrangement instructs the control arrangement to take control of the first vehicle.

18. The system of claim 15 wherein the first vehicle is configured to perform self-monitoring to identify a first potential issue, and wherein the first vehicle is further configured to provide the first supervisory request to the monitoring arrangement, the first supervisory request being arranged to identify the first potential issue.

19. The system of claim 15 wherein the control arrangement is a teleoperations arrangement is arranged to service the first supervisory request.

20. The system of claim 19 wherein the monitoring arrangement is arranged to service the first supervisory request to determine whether the first vehicle is to be controlled remotely by obtaining sensor information from the first vehicle.
